(19) United States
(12) Patent Application Publication
(10) Pub. No.: US 2025/0247761 A1
(43) Pub. Date: Jul. 31, 2025

(54) UPLINK POSITIONING METHODS IN HANDOVER OR CELL RESELECTION

(71) Applicant: QUALCOMM Incorporated, San Diego, CA (US)

(72) Inventors: Srinivas YERRAMALLI, San Diego, CA (US); Mukesh KUMAR, Hyderabad (IN); Alexandros MANOLAKOS, Athens (GR)

(21) Appl. No.: 18/853,950

(22) PCT Filed: May 12, 2023
(86) PCT No.: PCT/US2023/022043

§ 371 Date: Oct. 3, 2024

(30) Foreign Application Priority Data
Jun. 27, 2022 (GR) 20220100515

(51) Int. Cl. H04W 36/32; H04B 17/318; H04L 5/00; H04W 64/00

(52) U.S. Cl. CPC H04W 36/322; H04B 17/328; H04L 5/0053; H04W 64/003

(57) ABSTRACT

Techniques are utilizing positioning signals during handover or cell reselection procedures are provided. An example method for transmitting sounding reference signals includes obtaining sounding reference signal configuration information from a first station of a group of stations, wherein the sounding reference signal configuration is valid for each station in the group of stations, performing a handover or a cell reselection procedure with a second station, wherein the second station is one of the group of stations, and transmitting one or more sounding reference signals to the second station based on the sounding reference signal configuration information.

### CROSS-REFERENCE TO RELATED APPLICATION

This application claims the benefit of Greek patent application No. 20220100515, filed Jun. 27, 2022, entitled “UPLINK POSITIONING METHODS IN HANDOVER OR CELL RESELECTION,” which is assigned to the assignee hereof, and the entire contents of which are hereby incorporated herein by reference for all purposes.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, a fourth-generation (4G) service (e.g., Long Term Evolution (LTE) or WiMax), a fifth-generation (5G) service, etc. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Orthogonal Frequency Division Multiple Access (OFDMA), Time Division Multiple Access (TDMA), the Global System for Mobile access (GSM) variation of TDMA, etc.

A fifth generation (5G) mobile standard calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

### SUMMARY

An example method for transmitting sounding reference signals according to the disclosure includes obtaining sounding reference signal configuration information from a first station of a group of stations, wherein the sounding reference signal configuration is valid for each station in the group of stations, performing a handover or a cell reselection procedure with a second station, wherein the second station is one of the group of stations, and transmitting one or more sounding reference signals to the second station based on the sounding reference signal configuration information.

Implementations of such a method may include one or more of the following features. The group of stations may be included in a radio access network notification area. The group of stations may be included in a long term evolution radio access network tracking area. The sounding reference signal configuration information may be provided via a radio access network notification area update procedure. The second station may be configured with a first bandwidth part and the one or more sounding reference signals may be transmitted within the first bandwidth part. The sounding reference signal configuration information may be included in one or more system information blocks transmitted by the first station. The sounding reference signal configuration information may be received by a user equipment in a radio resource control inactive mode. The method may include receiving one or more downlink reference signals from one or more stations in the group of stations, determining sounding reference signal power requirements based at least in part on path loss information associated with the one or more downlink reference signals, and transmitting the one or more sounding reference signals based at least in part on the sounding reference signal power requirements. The sounding reference signal power requirements may be based on one or more downlink reference signals transmitted by the first station. The sounding reference signal power requirements may be based on one or more downlink reference signals transmitted by the second station. The one or more downlink reference signals may include a first received downlink reference signal and the sounding reference signal power requirements may be based on the first received downlink reference signal. An indication of a specific cell to be used as a positioning sounding reference signal path reference may be received, such that the sounding reference signal power requirements may be based on the one or more downlink reference signals transmitted by the specific cell. A station associated with a lowest path loss may be determined based on the one or more downlink reference signals, such that the sounding reference signal power requirements may be based on one or more downlink reference signals transmitted by the station associated with the lowest path loss. One or more positioning measurements may be provided to a network server, and receiving a location estimate from the network server may be based at least in part on the one or more positioning measurements.

An example method for transmitting sounding reference signals with a handover or cell reselection procedure according to the disclosure includes obtaining a first sounding reference signal configuration from a first station, performing the handover or cell reselection procedure with a second station, requesting a radio access network (RAN) notification area update from the second station, receiving RAN notification area information and a second sounding reference signal configuration from the second station, and transmitting one or more sounding reference signals based on the second sounding reference signal configuration.

Implementations of such a method may include one or more of the following features. The first station may be configured with a first bandwidth part and the one or more sounding reference signals based on the second sounding reference signal configuration may be transmitted within the first bandwidth part. The second station may be configured with a second bandwidth part and the one or more sounding reference signals based on the second sounding reference signal configuration may be transmitted within the second bandwidth part. The RAN notification area update may be included in one or more system information blocks transmitted by the second station. The RAN notification area update may be received by a user equipment in a radio resource control inactive mode. The method may include receiving one or more downlink reference signals from one or more stations identified in the RAN notification area information, determining sounding reference signal power requirements based at least in part on path loss information associated with the one or more downlink reference signals, and transmitting the one or more sounding reference signals based at least in part on the sounding reference signal power requirements. The sounding reference signal power requirements may be based on one or more downlink reference signals transmitted by the first station. The sounding reference signal power requirements may be based on one or more downlink reference signals transmitted by the second station. The one or more downlink reference signals may include a first received downlink reference signal and the sounding reference signal power requirements may be based on the first received downlink reference signal. An indication of a specific cell to be used as a positioning sounding reference signal path reference may be received in the RAN notification area information, such that the sounding reference signal power requirements may be based on the one or more downlink reference signals transmitted by the specific cell. A station associated with a lowest path loss may be determined based on the one or more downlink reference signals, such that the sounding reference signal power requirements may be based on one or more downlink reference signals transmitted by the station associated with the lowest path loss. One or more positioning measurements may be provided to a network server and receiving a location estimate from the network server may be based at least in part on the one or more positioning measurements.

An example method for delaying a positioning session based on a handover or cell reselection procedure according to the disclosure includes requesting positioning information associated with a mobile device, receiving an indication that a positioning session will be delayed based on a time required to complete the handover or cell reselection procedure, and receiving positioning measurements associated with the mobile device based at least in part on the indication that the positioning session will be delayed.

Implementations of such a method may include one or more of the following features. The indication that the positioning session will be delayed may be received from a mobility management function. The indication that the positioning session will be delayed may be based on historical handover or cell reselection procedures times associated with a first station and a second station.

Items and/or techniques described herein may provide one or more of the following capabilities, as well as other capabilities not mentioned. A first base station may be identified as one of a first group of base stations. Mobile devices, such as user equipment, may utilize the first base station as a serving cell and subsequently perform a handover or cell reselection procedure with other base stations in the first group of base stations based on a current location. The first base station may provide reference signal configuration and station identification information to the mobile device to define the first group of base stations and an associated reference signal configuration to use with each of the base stations in the first group of base stations. The reference signal configuration may be a sounding reference signal (SRS) configuration. During a positioning session, the mobile device may transmit SRS based on the SRS configuration received from the first base station to the other base stations in the first group of base stations. A handover or cell reselection procedure may occur concurrently with the positioning session. The mobile device may continue to transmit SRS based on the SRS configuration throughout the positioning session, including before, during, and after the handover or cell reselection procedure. The positioning session may continue without requiring a new serving cell (e.g., a second base station) to send a new SRS configuration (e.g., a second SRS configuration). The proposed procedure reduces messaging overhead and the latency associated with obtaining a location estimate during a handover or cell reselection procedure. A second group of base stations and a second SRS configuration may be defined when the mobile device moves out of the coverage area of the first group of base stations. Other capabilities may be provided and not every implementation according to the disclosure must provide any, let alone all, of the capabilities discussed.

### BRIEF DESCRIPTION OF THE DRAWINGS

FIG. 1 is a simplified diagram of an example wireless communications system.

FIG. 2 is a block diagram of components of an example user equipment shown in FIG. 1.

FIG. 3 is a block diagram of components of an example transmission/reception point.

FIG. 4 is a block diagram of components of a server, various examples of which are shown in FIG. 1.

FIGS. 5 and 6 are diagrams illustrating exemplary techniques for determining a position of a mobile device using information obtained from a plurality of base stations.

FIG. 7 is an example round trip message flow between a user equipment and a base station.

FIG. 8 is a diagram of example uplink positioning reference signals.

FIG. 9 is a diagram of example Radio Resource Control (RRC) state transitions.

FIG. 10 is an example Radio Access Network (RAN) Notification Area (RNA).

FIG. 11 is a timing diagram of an example cell change during a positioning session.

FIG. 12 is an example positioning measurement message flow with a cell handover or reselection procedure.

FIG. 13 is a portion of an example sounding reference signal (SRS) configuration information element.

FIG. 14 includes examples of an RNA and common SRS cell groups.

FIG. 15 is an example message flow for uplink positioning methods during handover or cell reselection procedures.

FIG. 16 is a process flow diagram of an example method for transmitting sounding reference signals.

FIG. 17 is a process flow diagram of an example method for transmitting sounding reference signals with a handover or cell reselection procedure.

FIG. 18 is a process flow diagram of an example method for delaying a positioning session based on a handover or cell reselection procedure.

FIG. 19 is a process flow diagram for transmitting sounding reference signals based on path loss information associated with a group of stations.

### DETAILED DESCRIPTION

Techniques are discussed herein for providing positioning signals during handover or cell reselection procedures. Current uplink positioning signals, such as SRS for positioning, are based on cell specific SRS configurations assigned by a base station (e.g., gNB) for a specific user equipment (UE). Thus, a UE must suspend SRS transmissions when it moves across cells. The techniques provided herein enable a UE to utilize the same SRS configuration for multiple cells. In an example, a common SRS configuration may be valid for a group of cells and the UE may utilize the SRS configuration when it moves across different cells in the group of cells. The UE may also be configured to report Receive-Transmit (Rx-Tx) values to the cells in the group of cells. In an example, the group of cells may be defined by a RAN-based Notification Area (RNA) and the SRS configuration information may be included in RNA update messaging and provided when the UE is in an inactive mode. A serving cell may be configured to update the SRS configuration information when the UE is in a connected mode. In an example, the UE may be configured to determine a path loss based on downlink signals transmitted from one or more of the group of cells, and determine an uplink transmission power for SRS transmitted to the group of cells. In an example, a positioning session may be delayed during a handover procedure. These techniques are examples, and not limitations, as other signaling techniques may be used.

Obtaining the locations of mobile devices that are accessing a wireless network may be useful for many applications including, for example, emergency calls, personal navigation, consumer asset tracking, locating a friend or family member, etc. Existing positioning methods include methods based on measuring radio signals transmitted from a variety of devices or entities including satellite vehicles (SVs) and terrestrial radio sources in a wireless network such as base stations and access points. It is expected that standardization for the 5G wireless networks will include support for various positioning methods, which may utilize reference signals transmitted by base stations in a manner similar to which LTE wireless networks currently utilize Positioning Reference Signals (PRS) and/or Cell-specific Reference Signals (CRS) for position determination.

The description may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various aspects described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, such UEs may be any wireless communication device (e.g., a mobile phone, router, tablet computer, laptop computer, consumer asset tracking device, Internet of Things (IoT) device, etc.) used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi networks (e.g., based on IEEE (Institute of Electrical and Electronics Engineers) 802.11, etc.) and so on.

A base station may operate according to one of several RATs in communication with UEs depending on the network in which it is deployed. Examples of a base station include an Access Point (AP), a Network Node, a NodeB, an evolved NodeB (eNB), or a general Node B (gNodeB, gNB). In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrowband Internet-of-Things (NB-IoT), enhanced mobile broadband (eMBB), or others) that may provide access for different types of devices. In some examples, the term “cell” may refer to a portion of a geographic coverage area (for example, a sector) over which the logical entity operates.

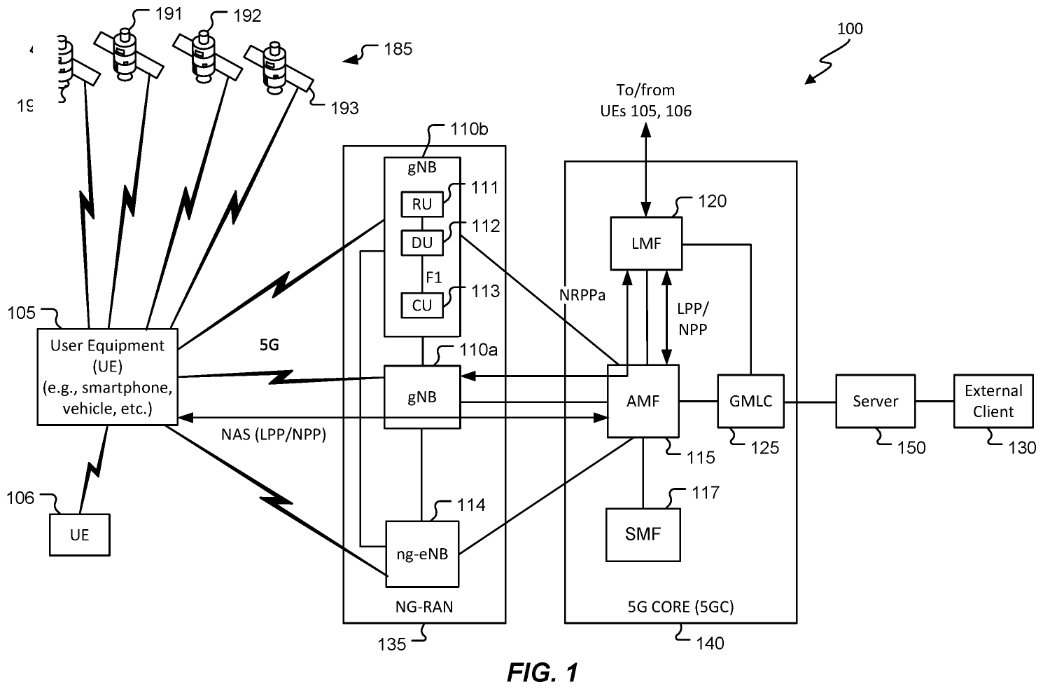

Referring to FIG. 1, an example of a communication system 100 includes a UE 105, a UE 106, a Radio Access Network (RAN), here a Fifth Generation (5G) Next Generation (NG) RAN (NG-RAN) 135, a 5G Core Network (5GC) 140, and a server 150. The UE 105 and/or the UE 106 may be, e.g., an IoT device, a location tracker device, a cellular telephone, a vehicle (e.g., a car, a truck, a bus, a boat, etc.), or other device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3rd Generation Partnership Project (3GPP). Accordingly, the NG-RAN 135 and the 5GC 140 may conform to current or future standards for 5G support from 3GPP. The NG-RAN 135 may be another type of RAN, e.g., a 3G RAN, a 4G Long Term Evolution (LTE) RAN, etc. The UE 106 may be configured and coupled similarly to the UE 105 to send and/or receive signals to/from similar other entities in the system 100, but such signaling is not indicated in FIG. 1 for the sake of simplicity of the figure. Similarly, the discussion focuses on the UE 105 for the sake of simplicity. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The gNBs 110a, 110b, and the ng-eNB 114 may be referred to as base stations (BSs). The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions. Base stations such as the gNBs 110a, 110b and/or the ng-eNB 114 may be a macro cell (e.g., a high-power cellular base station), or a small cell (e.g., a low-power cellular base station), or an access point (e.g., a short-range base station configured to communicate with short-range technology such as WiFi, WiFi-Direct (WiFi-D), Bluetooth®, Bluetooth®-low energy (BLE), Zigbee, etc. One or more base stations, e.g., one or more of the gNBs 110a, 110b and/or the ng-eNB 114 may be configured to communicate with the UE 105 via multiple carriers. Each of the gNBs 110a, 110b and/or the ng-eNB 114 may provide communication coverage for a respective geographic region, e.g. a cell. Each cell may be partitioned into multiple sectors as a function of the base station antennas.

FIG. 1 provides a generalized illustration of various components, any or all of which may be utilized as appropriate, and each of which may be duplicated or omitted as necessary. Specifically, although one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a, 110b are examples and may, in various embodiments, be replaced by or include various other location server functionality and/or base station functionality respectively.

The system 100 is capable of wireless communication in that components of the system 100 can communicate with one another (at least some times using wireless connections) directly or indirectly, e.g., via the gNBs 110a, 110b, the ng-eNB 114, and/or the 5GC 140 (and/or one or more other devices not shown, such as one or more other base transceiver stations). For indirect communications, the communications may be altered during transmission from one entity to another, e.g., to alter header information of data packets, to change format, etc. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples as the UE 105 is not required to be any of these configurations, and other configurations of UEs may be used. Other UEs may include wearable devices (e.g., smart watches, smart jewelry, smart glasses or headsets, etc.). Still other UEs may be used, whether currently existing or developed in the future. Further, other wireless devices (whether mobile or not) may be implemented within the system 100 and may communicate with each other and/or with the UE 105, the gNBs 110a, 110b, the ng-eNB 114, the 5GC 140, and/or the external client 130. For example, such other devices may include internet of thing (IoT) devices, medical devices, home entertainment and/or automation devices, etc. The 5GC 140 may communicate with the external client 130 (e.g., a computer system), e.g., to allow the external client 130 to request and/or receive location information regarding the UE 105 (e.g., via the GMLC 125).

The UE 105 or other devices may be configured to communicate in various networks and/or for various purposes and/or using various technologies (e.g., 5G, Wi-Fi communication, multiple frequencies of Wi-Fi communication, satellite positioning, one or more types of communications (e.g., GSM (Global System for Mobiles), CDMA (Code Division Multiple Access), LTE (Long Term Evolution), V2X (Vehicle-to-Everything, e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or WiFi (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105, 106 may communicate with each other through UE-to-UE sidelink (SL) communications by transmitting over one or more sidelink channels such as a physical sidelink synchronization channel (PSSCH), a physical sidelink broadcast channel (PSBCH), or a physical sidelink control channel (PSCCH).

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, consumer asset tracking device, navigation device, Internet of Things (IoT) device, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi (also referred to as Wi-Fi), Bluetooth® (BT), Worldwide Interoperability for Microwave Access (WiMAX), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi Direct (WiFi-D), Bluetooth®, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via D2D communications may utilize a one-to-many (1: M) system in which each UE may transmit to other UEs in the group. A TRP may facilitate scheduling of resources for D2D communications. In other cases, D2D communications may be carried out between UEs without the involvement of a TRP. One or more of a group of UEs utilizing D2D communications may be within a geographic coverage area of a TRP. Other UEs in such a group may be outside such geographic coverage areas, or be otherwise unable to receive transmissions from a base station. Groups of UEs communicating via D2D communications may utilize a one-to-many (1: M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g. the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The gNBs 110a, 110b and/or the ng-eNB 114 may each comprise one or more TRPs. For example, each sector within a cell of a BS may comprise a TRP, although multiple TRPs may share one or more components (e.g., share a processor but have separate antennas). The system 100 may include macro TRPs exclusively or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

Each of the gNBs 110a, 110b and/or the ng-eNB 114 may include a radio unit (RU), a distributed unit (DU), and a central unit (CU). For example, the gNB 110b includes an RU 111, a DU 112, and a CU 113. The RU 111, DU 112, and CU 113 divide functionality of the gNB 110b. While the gNB 110b is shown with a single RU, a single DU, and a single CU, a gNB may include one or more RUs, one or more DUs, and/or one or more CUs. An interface between the CU 113 and the DU 112 is referred to as an F1 interface. The RU 111 is configured to perform digital front end (DFE) functions (e.g., analog-to-digital conversion, filtering, power amplification, transmission/reception) and digital beamforming, and includes a portion of the physical (PHY) layer. The RU 111 may perform the DFE using massive multiple input/multiple output (MIMO) and may be integrated with one or more antennas of the gNB 110b. The DU 112 hosts the Radio Link Control (RLC), Medium Access Control (MAC), and physical layers of the gNB 110b. One DU can support one or more cells, and each cell is supported by a single DU. The operation of the DU 112 is controlled by the CU 113. The CU 113 is configured to perform functions for transferring user data, mobility control, radio access network sharing, positioning, session management, etc. although some functions are allocated exclusively to the DU 112. The CU 113 hosts the Radio Resource Control (RRC), Service Data Adaptation Protocol (SDAP), and Packet Data Convergence Protocol (PDCP) protocols of the gNB 110b. The UE 105 may communicate with the CU 113 via RRC, SDAP, and PDCP layers, with the DU 112 via the RLC, MAC, and PHY layers, and with the RU 111 via the PHY layer.

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications, or directly with the gNBs 110a, 110b and/or the ng-eNB 114. The LMF 120 may support positioning of the UE 105 when the UE 105 accesses the NG-RAN 135 and may support position procedures/methods such as Assisted GNSS (A-GNSS), Observed Time Difference of Arrival (OTDOA) (e.g., Downlink (DL) OTDOA or Uplink (UL) OTDOA), Round Trip Time (RTT), Multi-Cell RTT, Real Time Kinematic (RTK), Precise Point Positioning (PPP), Differential GNSS (DGNSS), Enhanced Cell ID (E-CID), angle of arrival (AoA), angle of departure (AoD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120 may be referred to by other names such as a Location Manager (LM), Location Function (LF), commercial LMF (CLMF), or value added LMF (VLMF). A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g. by the LMF 120). The AMF 115 may serve as a control node that processes signaling between the UE 105 and the 5GC 140, and may provide QoS (Quality of Service) flow and session management. The AMF 115 may support mobility of the UE 105 including cell change and handover and may participate in supporting signaling connection to the UE 105.

The server 150, e.g., a cloud server, is configured to obtain and provide location estimates of the UE 105 to the external client 130. The server 150 may, for example, be configured to run a microservice/service that obtains the location estimate of the UE 105. The server 150 may, for example, pull the location estimate from (e.g., by sending a location request to) the UE 105, one or more of the gNBs 110a, 110b (e.g., via the RU 111, the DU 112, and the CU 113) and/or the ng-eNB 114, and/or the LMF 120. As another example, the UE 105, one or more of the gNBs 110a, 110b (e.g., via the RU 111, the DU 112, and the CU 113), and/or the LMF 120 may push the location estimate of the UE 105 to the server 150.

The GMLC 125 may support a location request for the UE 105 received from the external client 130 via the server 150 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130 via the server 150. The GMLC 125 is shown connected to both the AMF 115 and LMF 120, though may not be connected to the AMF 115 or the LMF 120 in some implementations.

As further illustrated in FIG. 1, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 36.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110a, 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS or PRS transmissions from the gNBs 110a, 110b, and/or the ng-eNB 114. The LMF 120 may be co-located or integrated with a gNB or a TRP, or may be disposed remote from the gNB and/or the TRP and configured to communicate directly or indirectly with the gNB and/or the TRP.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time of Arrival (ToA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS or PRS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi AP). The UE 105 may send the measurement quantities back to the LMF 120 in an LPP or NPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such embodiments, the 5GC 140 may be configured to control different air interfaces. For example, the 5GC 140 may be connected to a WLAN using a Non-3GPP InterWorking Function (N3IWF, not shown FIG. 1) in the 5GC 140. For example, the WLAN may support IEEE 802.11 WiFi access for the UE 105 and may comprise one or more WiFi APs. Here, the N3IWF may connect to the WLAN and to other elements in the 5GC 140 such as the AMF 115. In some embodiments, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-UTRAN and may use LPP to support positioning of the UE 105. In these other embodiments, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi APs, an MME, and an E-SMLC.

As noted, in some embodiments, positioning functionality may be implemented, at least in part, using the directional SS or PRS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS or PRS beams from a plurality of base stations (such as the gNBs 110a, 110b, the ng-eNB 114, etc.) to compute the UE's position.

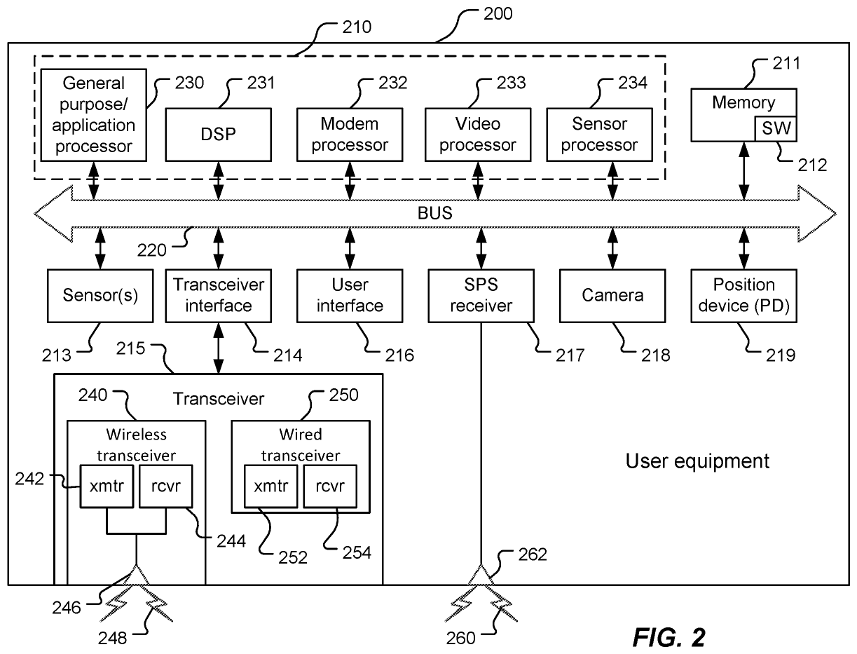

Referring also to FIG. 2, a UE 200 is an example of one of the UEs 105, 106 and comprises a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the UE 200. The processor 210 may include one or more intelligent hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identify, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 is a non-transitory storage medium that may include random access memory (RAM), flash memory, disc memory, and/or read-only memory (ROM), etc. The memory 211 stores the software 212 which may be processor-readable, processor-executable software code containing instructions that are configured to, when executed, cause the processor 210 to perform various functions described herein. Alternatively, the software 212 may not be directly executable by the processor 210 but may be configured to cause the processor 210, e.g., when compiled and executed, to perform the functions. The description may refer to the processor 210 performing a function, but this includes other implementations such as where the processor 210 executes software and/or firmware. The description may refer to the processor 210 performing a function as shorthand for one or more of the processors 230-234 performing the function. The description may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE includes one or more of the processors 230-234 of the processor 210, the memory 211, and the wireless transceiver 240. Other example configurations include one or more of the processors 230-234 of the processor 210, the memory 211, a wireless transceiver, and one or more of the sensor(s) 213, the user interface 216, the SPS receiver 217, the camera 218, the PD 219, and/or a wired transceiver.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose/application processor 230 and/or the DSP 231. Other configurations, however, may be used to perform baseband processing.

The UE 200 may include the sensor(s) 213 that may include, for example, one or more of various types of sensors such as one or more inertial sensors, one or more magnetometers, one or more environment sensors, one or more optical sensors, one or more weight sensors, and/or one or more radio frequency (RF) sensors, etc. An inertial measurement unit (IMU) may comprise, for example, one or more accelerometers (e.g., collectively responding to acceleration of the UE 200 in three dimensions) and/or one or more gyroscopes (e.g., three-dimensional gyroscope(s)). The sensor(s) 213 may include one or more magnetometers (e.g., three-dimensional magnetometer(s)) to determine orientation (e.g., relative to magnetic north and/or true north) that may be used for any of a variety of purposes, e.g., to support one or more compass applications. The environment sensor(s) may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the general-purpose/application processor 230 in support of one or more applications such as, for example, applications directed to positioning and/or navigation operations.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile and/or whether to report certain useful information to the LMF 120 regarding the mobility of the UE 200. For example, based on the information obtained/measured by the sensor(s) 213, the UE 200 may notify/report to the LMF 120 that the UE 200 has detected movements or that the UE 200 has moved, and report the relative displacement/distance (e.g., via dead reckoning, or sensor-based location determination, or sensor-assisted location determination enabled by the sensor(s) 213). In another example, for relative positioning information, the sensors/IMU can be used to determine the angle and/or orientation of the other device with respect to the UE 200, etc.

The IMU may be configured to provide measurements about a direction of motion and/or a speed of motion of the UE 200, which may be used in relative location determination. For example, one or more accelerometers and/or one or more gyroscopes of the IMU may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) and gyroscope(s) taken after this moment in time may be used in dead reckoning to determine present location of the UE 200 based on movement (direction and distance) of the UE 200 relative to the reference location.

The magnetometer(s) may determine magnetic field strengths in different directions which may be used to determine orientation of the UE 200. For example, the orientation may be used to provide a digital compass for the UE 200. The magnetometer(s) may include a two-dimensional magnetometer configured to detect and provide indications of magnetic field strength in two orthogonal dimensions. The magnetometer(s) may include a three-dimensional magnetometer configured to detect and provide indications of magnetic field strength in three orthogonal dimensions. The magnetometer(s) may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to an antenna 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to wired (e.g., electrical and/or optical) signals and from wired (e.g., electrical and/or optical) signals to the wireless signals 248. The wireless transmitter 242 includes appropriate components (e.g., a power amplifier and a digital-to-analog converter). The wireless receiver 244 includes appropriate components (e.g., one or more amplifiers, one or more frequency filters, and an analog-to-digital converter). The wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. New Radio may use mm-wave frequencies and/or sub-6 GHZ frequencies. The wired transceiver 250 may include a wired transmitter 252 and a wired receiver 254 configured for wired communication, e.g., a network interface that may be utilized to communicate with the NG-RAN 135 to send communications to, and receive communications from, the NG-RAN 135. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215. The wireless transmitter 242, the wireless receiver 244, and/or the antenna 246 may include multiple transmitters, multiple receivers, and/or multiple antennas, respectively, for sending and/or receiving, respectively, appropriate signals.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose/application processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The SPS antenna 262 is configured to transduce the SPS signals 260 from wireless signals to wired signals, e.g., electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose/application processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose/application processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS (Complementary Metal-Oxide Semiconductor) imager), a lens, analog-to-digital circuitry, frame buffers, etc. Additional processing, conditioning, encoding, and/or compression of signals representing captured images may be performed by the general-purpose/application processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position device (PD) 219 may be configured to determine a position of the UE 200, motion of the UE 200, and/or relative position of the UE 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer to the PD 219 being configured to perform, or performing, in accordance with the positioning method(s). The PD 219 may also or alternatively be configured to determine location of the UE 200 using terrestrial-based signals (e.g., at least some of the wireless signals 248) for trilateration, for assistance with obtaining and using the SPS signals 260, or both. The PD 219 may be configured to determine location of the UE 200 based on a cell of a serving base station (e.g., a cell center) and/or another technique such as E-CID. The PD 219 may be configured to use one or more images from the camera 218 and image recognition combined with known locations of landmarks (e.g., natural landmarks such as mountains and/or artificial landmarks such as buildings, bridges, streets, etc.) to determine location of the UE 200. The PD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the general-purpose/application processor 230 and/or the DSP 231) may be configured to use to determine motion (e.g., a velocity vector and/or an acceleration vector) of the UE 200. The PD 219 may be configured to provide indications of uncertainty and/or error in the determined position and/or motion. Functionality of the PD 219 may be provided in a variety of manners and/or configurations, e.g., by the general-purpose/application processor 230, the transceiver 215, the SPS receiver 217, and/or another component of the UE 200, and may be provided by hardware, software, firmware, or various combinations thereof.

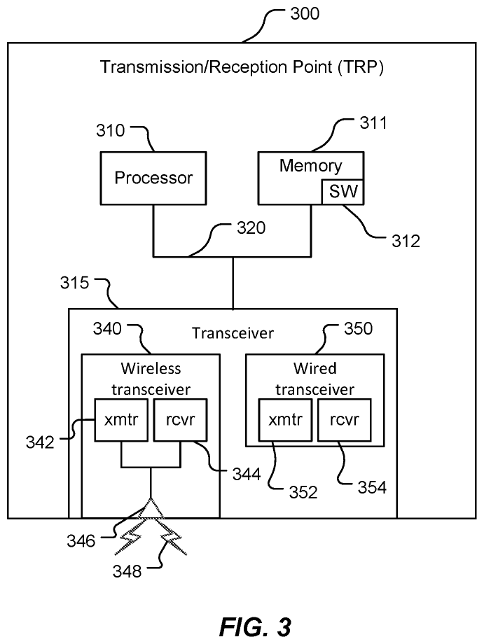

Referring also to FIG. 3, an example of a TRP 300 of the gNBs 110a, 110b and/or the ng-eNB 114 comprises a computing platform including a processor 310, memory 311 including software (SW) 312, and a transceiver 315. The processor 310, the memory 311, and the transceiver 315 may be communicatively coupled to each other by a bus 320 (which may be configured, e.g., for optical and/or electrical communication). One or more of the shown apparatus (e.g., a wireless transceiver) may be omitted from the TRP 300. The processor 310 may include one or more intelligent hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 is a non-transitory storage medium that may include random access memory (RAM)), flash memory, disc memory, and/or read-only memory (ROM), etc. The memory 311 stores the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions.

The description may refer to the processor 310 performing a function, but this includes other implementations such as where the processor 310 executes software and/or firmware. The description may refer to the processor 310 performing a function as shorthand for one or more of the processors contained in the processor 310 performing the function. The description may refer to the TRP 300 performing a function as shorthand for one or more appropriate components (e.g., the processor 310 and the memory 311) of the TRP 300 (and thus of one of the gNBs 110a, 110b and/or the ng-eNB 114) performing the function. The processor 310 may include a memory with stored instructions in addition to and/or instead of the memory 311. Functionality of the processor 310 is discussed more fully below.

The transceiver 315 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to wired (e.g., electrical and/or optical) signals and from wired (e.g., electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 350 may include a wired transmitter 352 and a wired receiver 354 configured for wired communication, e.g., a network interface that may be utilized to communicate with the NG-RAN 135 to send communications to, and receive communications from, the LMF 120, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 is configured to perform or performs several functions, but one or more of these functions may be performed by the LMF 120 and/or the UE 200 (i.e., the LMF 120 and/or the UE 200 may be configured to perform one or more of these functions).

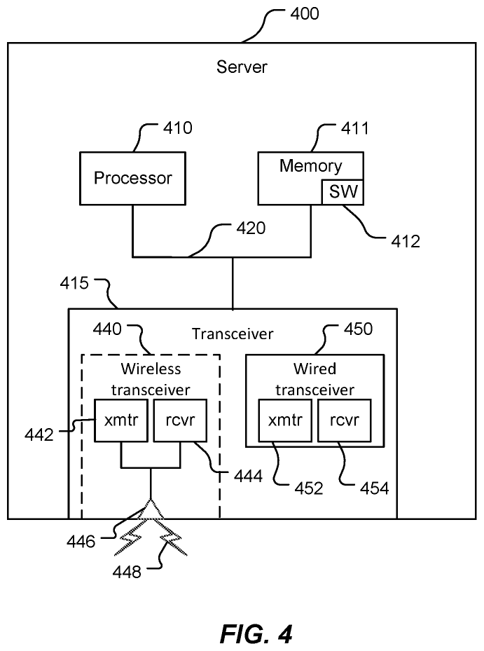

Referring also to FIG. 4, a server 400, of which the LMF 120 is an example, comprises a computing platform including a processor 410, memory 411 including software (SW) 412, and a transceiver 415. The processor 410, the memory 411, and the transceiver 415 may be communicatively coupled to each other by a bus 420 (which may be configured, e.g., for optical and/or electrical communication). One or more of the shown apparatus (e.g., a wireless transceiver) may be omitted from the server 400. The processor 410 may include one or more intelligent hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 is a non-transitory storage medium that may include random access memory (RAM)), flash memory, disc memory, and/or read-only memory (ROM), etc. The memory 411 stores the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description may refer to the processor 410 performing a function, but this includes other implementations such as where the processor 410 executes software and/or firmware. The description may refer to the processor 410 performing a function as shorthand for one or more of the processors contained in the processor 410 performing the function. The description may refer to the server 400 performing a function as shorthand for one or more appropriate components of the server 400 performing the function. The processor 410 may include at least one memory with stored instructions in addition to and/or instead of the memory 411. Functionality of the processor 410 is discussed more fully below.

The transceiver 415 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to wired (e.g., electrical and/or optical) signals and from wired (e.g., electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 450 may include a wired transmitter 452 and a wired receiver 454 configured for wired communication, e.g., a network interface that may be utilized to communicate with the NG-RAN 135 to send communications to, and receive communications from, the TRP 300, for example, and/or one or more other network entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The description herein may refer to the processor 410 performing a function, but this includes other implementations such as where the processor 410 executes software (stored in the memory 411) and/or firmware. The description herein may refer to the server 400 performing a function as shorthand for one or more appropriate components (e.g., the processor 410 and the memory 411) of the server 400 performing the function.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

For terrestrial positioning of a UE in cellular networks, techniques such as Advanced Forward Link Trilateration (AFLT) and Observed Time Difference Of Arrival (OTDOA) often operate in “UE-assisted” mode in which measurements of reference signals (e.g., PRS, CRS, etc.) transmitted by base stations are taken by the UE and then provided to a location server. The location server then calculates the position of the UE based on the measurements and known locations of the base stations. Because these techniques use the location server to calculate the position of the UE, rather than the UE itself, these positioning techniques are not frequently used in applications such as car or cell-phone navigation, which instead typically rely on satellite-based positioning.

A UE may use a Satellite Positioning System (SPS) (a Global Navigation Satellite System (GNSS)) for high-accuracy positioning using precise point positioning (PPP) or real time kinematic (RTK) technology. These technologies use assistance data such as measurements from ground-based stations. LTE Release 15 allows the data to be encrypted so that the UEs subscribed to the service exclusively can read the information. Such assistance data varies with time. Thus, a UE subscribed to the service may not easily “break encryption” for other UEs by passing on the data to other UEs that have not paid for the subscription. The passing on would need to be repeated every time the assistance data changes.

In UE-assisted positioning, the UE sends measurements (e.g., TDOA, Angle of Arrival (AoA), etc.) to the positioning server (e.g., LMF/eSMLC). The positioning server has the base station almanac (BSA) that contains multiple ‘entries’ or ‘records’, one record per cell, where each record contains geographical cell location but also may include other data. An identifier of the ‘record’ among the multiple ‘records’ in the BSA may be referenced. The BSA and the measurements from the UE may be used to compute the position of the UE.

In conventional UE-based positioning, a UE computes its own position, thus avoiding sending measurements to the network (e.g., location server), which in turn improves latency and scalability. The UE uses relevant BSA record information (e.g., locations of gNBs (more broadly base stations)) from the network. The BSA information may be encrypted. But since the BSA information varies much less often than, for example, the PPP or RTK assistance data described earlier, it may be easier to make the BSA information (compared to the PPP or RTK information) available to UEs that did not subscribe and pay for decryption keys. Transmissions of reference signals by the gNBs make BSA information potentially accessible to crowd-sourcing or war-driving, essentially enabling BSA information to be generated based on in-the-field and/or over-the-top observations.

Positioning techniques may be characterized and/or assessed based on one or more criteria such as position determination accuracy and/or latency. Latency is a time elapsed between an event that triggers determination of position-related data and the availability of that data at a positioning system interface, e.g., an interface of the LMF 120. At initialization of a positioning system, the latency for the availability of position-related data is called time to first fix (TTFF), and is larger than latencies after the TTFF. An inverse of a time elapsed between two consecutive position-related data availabilities is called an update rate, i.e., the rate at which position-related data are generated after the first fix. Latency may depend on processing capability, e.g., of the UE. For example, a UE may report a processing capability of the UE as a duration of DL PRS symbols in units of time (e.g., milliseconds) that the UE can process every T amount of time (e.g., T ms) assuming 272 PRB (Physical Resource Block) allocation. Other examples of capabilities that may affect latency are a number of TRPs from which the UE can process PRS, a number of PRS that the UE can process, and a bandwidth of the UE.

One or more of many different positioning techniques (also called positioning methods) may be used to determine position of an entity such as one of the UEs 105, 106. For example, known position-determination techniques include RTT, multi-RTT, OTDOA (also called TDOA and including UL-TDOA and DL-TDOA), Enhanced Cell Identification (E-CID), DL-AoD, UL-AoA, etc. RTT uses a time for a signal to travel from one entity to another and back to determine a range between the two entities. The range, plus a known location of a first one of the entities and an angle between the two entities (e.g., an azimuth angle) can be used to determine a location of the second of the entities. In multi-RTT (also called multi-cell RTT), multiple ranges from one entity (e.g., a UE) to other entities (e.g., TRPs) and known locations of the other entities may be used to determine the location of the one entity. In TDOA techniques, the difference in travel times between one entity and other entities may be used to determine relative ranges from the other entities and those, combined with known locations of the other entities may be used to determine the location of the one entity. Angles of arrival and/or departure may be used to help determine location of an entity. For example, an angle of arrival or an angle of departure of a signal combined with a range between devices (determined using signal, e.g., a travel time of the signal, a received power of the signal, etc.) and a known location of one of the devices may be used to determine a location of the other device. The angle of arrival or departure may be an azimuth angle relative to a reference direction such as true north. The angle of arrival or departure may be a zenith angle relative to directly upward from an entity (i.e., relative to radially outward from a center of Earth). E-CID uses the identity of a serving cell, the timing advance (i.e., the difference between receive and transmit times at the UE), estimated timing and power of detected neighbor cell signals, and possibly angle of arrival (e.g., of a signal at the UE from the base station or vice versa) to determine location of the UE. In TDOA, the difference in arrival times at a receiving device of signals from different sources along with known locations of the sources and known offset of transmission times from the sources are used to determine the location of the receiving device.

In a network-centric RTT estimation, the serving base station instructs the UE to scan for/receive RTT measurement signals (e.g., PRS) on serving cells of two or more neighboring base stations (and typically the serving base station, as at least three base stations are needed). The one of more base stations transmit RTT measurement signals on low reuse resources (e.g., resources used by the base station to transmit system information) allocated by the network (e.g., a location server such as the LMF 120). The UE records the arrival time (also referred to as a receive time, a reception time, a time of reception, or a time of arrival (ToA)) of each RTT measurement signal relative to the UE's current downlink timing (e.g., as derived by the UE from a DL signal received from its serving base station), and transmits a common or individual RTT response message (e.g., SRS (sounding reference signal) for positioning, i.e., UL-PRS) to the one or more base stations (e.g., when instructed by its serving base station) and may include the time difference TRx-Tx (i.e., UE TRx-Tx or UERx-Tx) between the ToA of the RTT measurement signal and the transmission time of the RTT response message in a payload of each RTT response message. The RTT response message would include a reference signal from which the base station can deduce the ToA of the RTT response. By comparing the difference TTx-Rx between the transmission time of the RTT measurement signal from the base station and the ToA of the RTT response at the base station to the UE-reported time difference TRx-Tx, the base station can deduce the propagation time between the base station and the UE, from which the base station can determine the distance between the UE and the base station by assuming the speed of light during this propagation time.

A UE-centric RTT estimation is similar to the network-based method, except that the UE transmits uplink RTT measurement signal(s) (e.g., when instructed by a serving base station), which are received by multiple base stations in the neighborhood of the UE. Each involved base station responds with a downlink RTT response message, which may include the time difference between the ToA of the RTT measurement signal at the base station and the transmission time of the RTT response message from the base station in the RTT response message payload.

For both network-centric and UE-centric procedures, the side (network or UE) that performs the RTT calculation typically (though not always) transmits the first message(s) or signal(s) (e.g., RTT measurement signal(s)), while the other side responds with one or more RTT response message(s) or signal(s) that may include the difference between the ToA of the first message(s) or signal(s) and the transmission time of the RTT response message(s) or signal(s).

A multi-RTT technique may be used to determine position. For example, a first entity (e.g., a UE) may send out one or more signals (e.g., unicast, multicast, or broadcast from the base station) and multiple second entities (e.g., other TSPs such as base station(s) and/or UE(s)) may receive a signal from the first entity and respond to this received signal. The first entity receives the responses from the multiple second entities. The first entity (or another entity such as an LMF) may use the responses from the second entities to determine ranges to the second entities and may use the multiple ranges and known locations of the second entities to determine the location of the first entity by trilateration.

In some instances, additional information may be obtained in the form of an angle of arrival (AoA) or angle of departure (AoD) that defines a straight-line direction (e.g., which may be in a horizontal plane or in three dimensions) or possibly a range of directions (e.g., for the UE from the locations of base stations). The intersection of two directions can provide another estimate of the location for the UE.

For positioning techniques using PRS (Positioning Reference Signal) signals (e.g., TDOA and RTT), PRS signals sent by multiple TRPs are measured and the arrival times of the signals, known transmission times, and known locations of the TRPs used to determine ranges from a UE to the TRPs. For example, an RSTD (Reference Signal Time Difference) may be determined for PRS signals received from multiple TRPs and used in a TDOA technique to determine position (location) of the UE. A positioning reference signal may be referred to as a PRS or a PRS signal. The PRS signals are typically sent using the same power and PRS signals with the same signal characteristics (e.g., same frequency shift) may interfere with each other such that a PRS signal from a more distant TRP may be overwhelmed by a PRS signal from a closer TRP such that the signal from the more distant TRP may not be detected. PRS muting may be used to help reduce interference by muting some PRS signals (reducing the power of the PRS signal, e.g., to zero and thus not transmitting the PRS signal). In this way, a weaker (at the UE) PRS signal may be more easily detected by the UE without a stronger PRS signal interfering with the weaker PRS signal. The term RS, and variations thereof (e.g., PRS, SRS, CSI-RS (Channel State Information-Reference Signal)), may refer to one reference signal or more than one reference signal.

Positioning reference signals (PRS) include downlink PRS (DL PRS, often referred to simply as PRS) and uplink PRS (UL PRS) (which may be called SRS (Sounding Reference Signal) for positioning). A PRS may comprise a PN code (pseudorandom number code) or be generated using a PN code (e.g., by modulating a carrier signal with the PN code) such that a source of the PRS may serve as a pseudo-satellite (a pseudolite). The PN code may be unique to the PRS source (at least within a specified area such that identical PRS from different PRS sources do not overlap). PRS may comprise PRS resources and/or PRS resource sets of a frequency layer. A DL PRS positioning frequency layer (or simply a frequency layer) is a collection of DL PRS resource sets, from one or more TRPs, with PRS resource(s) that have common parameters configured by higher-layer parameters DL-PRS-PositioningIFrequencyLayer, DL-PRS-ResourceSet, and DL-PRS-Resource. Each frequency layer has a DL PRS subcarrier spacing (SCS) for the DL PRS resource sets and the DL PRS resources in the frequency layer. Each frequency layer has a DL PRS cyclic prefix (CP) for the DL PRS resource sets and the DL PRS resources in the frequency layer. In 5G, a resource block occupies 12 consecutive subcarriers and a specified number of symbols. Common resource blocks are the set of resource blocks that occupy a channel bandwidth. A bandwidth part (BWP) is a set of contiguous common resource blocks and may include all the common resource blocks within a channel bandwidth or a subset of the common resource blocks. Also, a DL PRS Point A parameter defines a frequency of a reference resource block (and the lowest subcarrier of the resource block), with DL PRS resources belonging to the same DL PRS resource set having the same Point A and all DL PRS resource sets belonging to the same frequency layer having the same Point A. A frequency layer also has the same DL PRS bandwidth, the same start PRB (and center frequency), and the same value of comb size (i.e., a frequency of PRS resource elements per symbol such that for comb-N, every N^{th} resource element is a PRS resource element). A PRS resource set is identified by a PRS resource set ID and may be associated with a particular TRP (identified by a cell ID) transmitted by an antenna panel of a base station. A PRS resource ID in a PRS resource set may be associated with an omnidirectional signal, and/or with a single beam (and/or beam ID) transmitted from a single base station (where a base station may transmit one or more beams). Each PRS resource of a PRS resource set may be transmitted on a different beam and as such, a PRS resource (or simply resource) can also be referred to as a beam. This does not have any implications on whether the base stations and the beams on which PRS are transmitted are known to the UE.

A TRP may be configured, e.g., by instructions received from a server and/or by software in the TRP, to send DL PRS per a schedule. According to the schedule, the TRP may send the DL PRS intermittently, e.g., periodically at a consistent interval from an initial transmission. The TRP may be configured to send one or more PRS resource sets. A resource set is a collection of PRS resources across one TRP, with the resources having the same periodicity, a common muting pattern configuration (if any), and the same repetition factor across slots. Each of the PRS resource sets comprises multiple PRS resources, with each PRS resource comprising multiple OFDM (Orthogonal Frequency Division Multiplexing) Resource Elements (REs) that may be in multiple Resource Blocks (RBs) within N (one or more) consecutive symbol(s) within a slot. PRS resources (or reference signal (RS) resources generally) may be referred to as OFDM PRS resources (or OFDM RS resources). An RB is a collection of REs spanning a quantity of one or more consecutive symbols in the time domain and a quantity (12 for a 5G RB) of consecutive sub-carriers in the frequency domain. Each PRS resource is configured with an RE offset, slot offset, a symbol offset within a slot, and a number of consecutive symbols that the PRS resource may occupy within a slot. The RE offset defines the starting RE offset of the first symbol within a DL PRS resource in frequency. The relative RE offsets of the remaining symbols within a DL PRS resource are defined based on the initial offset. The slot offset is the starting slot of the DL PRS resource with respect to a corresponding resource set slot offset. The symbol offset determines the starting symbol of the DL PRS resource within the starting slot. Transmitted REs may repeat across slots, with each transmission being called a repetition such that there may be multiple repetitions in a PRS resource. The DL PRS resources in a DL PRS resource set are associated with the same TRP and each DL PRS resource has a DL PRS resource ID. A DL PRS resource ID in a DL PRS resource set is associated with a single beam transmitted from a single TRP (although a TRP may transmit one or more beams).

A PRS resource may also be defined by quasi-co-location and start PRB parameters. A quasi-co-location (QCL) parameter may define any quasi-co-location information of the DL PRS resource with other reference signals. The DL PRS may be configured to be QCL type D with a DL PRS or SS/PBCH (Synchronization Signal/Physical Broadcast Channel) Block from a serving cell or a non-serving cell. The DL PRS may be configured to be QCL type C with an SS/PBCH Block from a serving cell or a non-serving cell. The start PRB parameter defines the starting PRB index of the DL PRS resource with respect to reference Point A. The starting PRB index has a granularity of one PRB and may have a minimum value of 0 and a maximum value of 2176 PRBs.

A PRS resource set is a collection of PRS resources with the same periodicity, same muting pattern configuration (if any), and the same repetition factor across slots. Every time all repetitions of all PRS resources of the PRS resource set are configured to be transmitted is referred as an “instance”. Therefore, an “instance” of a PRS resource set is a specified number of repetitions for each PRS resource and a specified number of PRS resources within the PRS resource set such that once the specified number of repetitions are transmitted for each of the specified number of PRS resources, the instance is complete. An instance may also be referred to as an “occasion.” A DL PRS configuration including a DL PRS transmission schedule may be provided to a UE to facilitate (or even enable) the UE to measure the DL PRS.

Multiple frequency layers of PRS may be aggregated to provide an effective bandwidth that is larger than any of the bandwidths of the layers individually. Multiple frequency layers of component carriers (which may be consecutive and/or separate) and meeting criteria such as being quasi co-located (QCLed), and having the same antenna port, may be stitched to provide a larger effective PRS bandwidth (for DL PRS and UL PRS) resulting in increased time of arrival measurement accuracy. Stitching comprises combining PRS measurements over individual bandwidth fragments into a unified piece such that the stitched PRS may be treated as having been taken from a single measurement. Being QCLed, the different frequency layers behave similarly, enabling stitching of the PRS to yield the larger effective bandwidth. The larger effective bandwidth, which may be referred to as the bandwidth of an aggregated PRS or the frequency bandwidth of an aggregated PRS, provides for better time-domain resolution (e.g., of TDOA). An aggregated PRS includes a collection of PRS resources and each PRS resource of an aggregated PRS may be called a PRS component, and each PRS component may be transmitted on different component carriers, bands, or frequency layers, or on different portions of the same band.

RTT positioning is an active positioning technique in that RTT uses positioning signals sent by TRPs to UEs and by UEs (that are participating in RTT positioning) to TRPs. The TRPs may send DL-PRS signals that are received by the UEs and the UEs may send SRS (Sounding Reference Signal) signals that are received by multiple TRPs. A sounding reference signal may be referred to as an SRS or an SRS signal. In 5G multi-RTT, coordinated positioning may be used with the UE sending a single UL-SRS for positioning that is received by multiple TRPs instead of sending a separate UL-SRS for positioning for each TRP. A TRP that participates in multi-RTT will typically search for UEs that are currently camped on that TRP (served UEs, with the TRP being a serving TRP) and also UEs that are camped on neighboring TRPs (neighbor UEs). Neighbor TRPs may be TRPs of a single BTS (Base Transceiver Station) (e.g., gNB), or may be a TRP of one BTS and a TRP of a separate BTS. For RTT positioning, including multi-RTT positioning, the DL-PRS signal and the UL-SRS for positioning signal in a PRS/SRS for positioning signal pair used to determine RTT (and thus used to determine range between the UE and the TRP) may occur close in time to each other such that errors due to UE motion and/or UE clock drift and/or TRP clock drift are within acceptable limits. For example, signals in a PRS/SRS for positioning signal pair may be transmitted from the TRP and the UE, respectively, within about 10 ms of each other. With SRS for positioning being sent by UEs, and with PRS and SRS for positioning being conveyed close in time to each other, it has been found that radio-frequency (RF) signal congestion may result (which may cause excessive noise, etc.) especially if many UEs attempt positioning concurrently and/or that computational congestion may result at the TRPs that are trying to measure many UEs concurrently.

RTT positioning may be UE-based or UE-assisted. In UE-based RTT, the UE 200 determines the RTT and corresponding range to each of the TRPs 300 and the position of the UE 200 based on the ranges to the TRPs 300 and known locations of the TRPs 300. In UE-assisted RTT, the UE 200 measures positioning signals and provides measurement information to the TRP 300, and the TRP 300 determines the RTT and range. The TRP 300 provides ranges to a location server, e.g., the server 400, and the server determines the location of the UE 200, e.g., based on ranges to different TRPs 300. The RTT and/or range may be determined by the TRP 300 that received the signal(s) from the UE 200, by this TRP 300 in combination with one or more other devices, e.g., one or more other TRPs 300 and/or the server 400, or by one or more devices other than the TRP 300 that received the signal(s) from the UE 200.

Various positioning techniques are supported in 5G NR. The NR native positioning methods supported in 5G NR include DL-only positioning methods, UL-only positioning methods, and DL+UL positioning methods. Downlink-based positioning methods include DL-TDOA and DL-AoD. Uplink-based positioning methods include UL-TDOA and UL-AoA. Combined DL+UL-based positioning methods include RTT with one base station and RTT with multiple base stations (multi-RTT).

A position estimate (e.g., for a UE) may be referred to by other names, such as a location estimate, location, position, position fix, fix, or the like. A position estimate may be geodetic and comprise coordinates (e.g., latitude, longitude, and possibly altitude) or may be civic and comprise a street address, postal address, or some other verbal description of a location. A position estimate may further be defined relative to some other known location or defined in absolute terms (e.g., using latitude, longitude, and possibly altitude). A position estimate may include an expected error or uncertainty (e.g., by including an area or volume within which the location is expected to be included with some specified or default level of confidence).

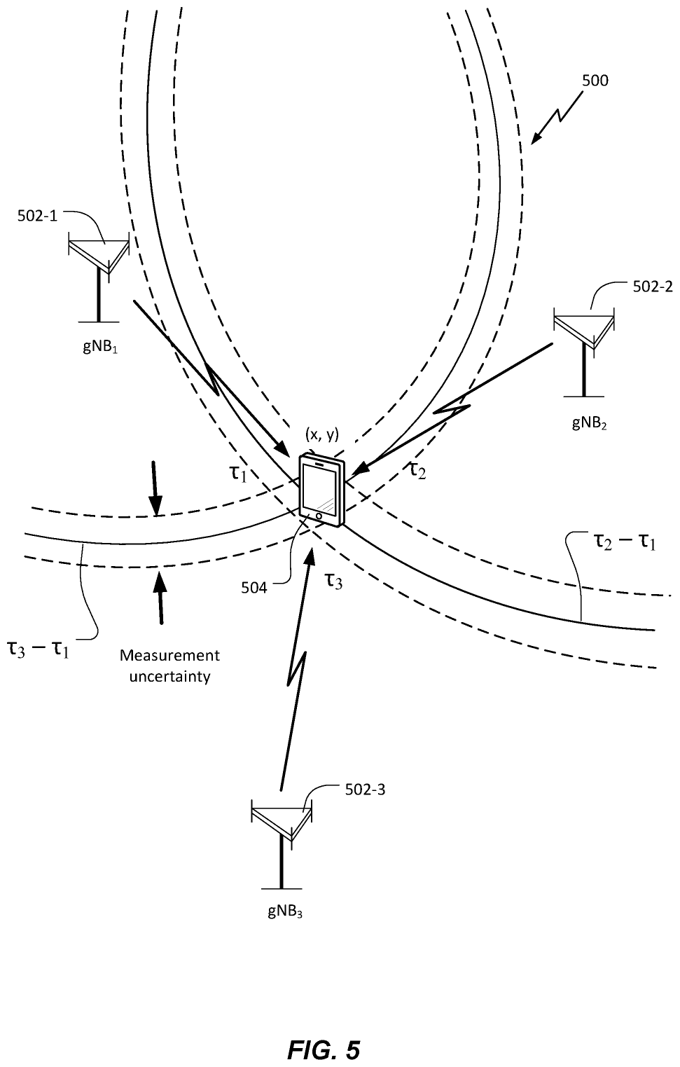

Referring to FIG. 5, an exemplary wireless communications system 500 according to various aspects of the disclosure is shown. In the example of FIG. 5, a UE 504, which may correspond to any of the UEs described herein, is attempting to calculate an estimate of its position, or assist another entity (e.g., a base station or core network component, another UE, a location server, a third party application, etc.) to calculate an estimate of its position. The UE 504 may communicate wirelessly with a plurality of base stations 502-1, 502-2, and 502-3 which may correspond to any combination of the base stations described herein, using RF signals and standardized protocols for the modulation of the RF signals and the exchange of information packets. By extracting different types of information from the exchanged RF signals, and utilizing the layout of the wireless communications system 500 (e.g., the base stations locations, orientation of the antennas, geometry, etc.), the UE 504 may determine its position, or assist in the determination of its position, in a predefined reference coordinate system. In an aspect, the UE 504 may specify its position using a two-dimensional (2D) coordinate system; however, the aspects disclosed herein are not so limited, and may also be applicable to determining positions using a three-dimensional (3D) coordinate system, if the extra dimension is desired. Additionally, while FIG. 5 illustrates one UE 504 and three base stations 502-1, 502-2, 502-3, as will be appreciated, there may be more UEs 504 and more or fewer base stations.

To support position estimates, the base stations 502-1, 502-2, 502-3 may be configured to broadcast positioning reference signals (e.g., PRS, NRS, TRS, CRS, etc.) to UEs in their coverage area to enable a UE 504 to measure characteristics of such reference signals. For example, the observed time difference of arrival (OTDOA) positioning method is a multilateration method in which the UE 504 measures the time difference, known as a reference signal time difference (RSTD), between specific reference signals (e.g., PRS, CRS, CSI-RS, etc.) transmitted by different pairs of network nodes (e.g., base stations, antennas of base stations, etc.) and either reports these time differences to a location server, such as the server 400 (e.g., the LMF 120), or computes a location estimate itself from these time differences.

Generally, RSTDs are measured between a reference network node (e.g., base station 502-1 in the example of FIG. 5) and one or more neighbor network nodes (e.g., base stations 502-2 and 502-3 in the example of FIG. 5). The reference network node remains the same for all RSTDs measured by the UE 504 for any single positioning use of OTDOA and would typically correspond to the serving cell for the UE 504 or another nearby cell with good signal strength at the UE 504. In an aspect, where a measured network node is a cell supported by a base station, the neighbor network nodes would normally be cells supported by base stations different from the base station for the reference cell and may have good or poor signal strength at the UE 504. The location computation can be based on the measured time differences (e.g., RSTDs) and knowledge of the network nodes' locations and relative transmission timing (e.g., regarding whether network nodes are accurately synchronized or whether each network node transmits with some known time difference relative to other network nodes).

To assist positioning operations, a location server (e.g., server 400, LMF 120) may provide OTDOA assistance data to the UE 504 for the reference network node (e.g., base station 502-1 in the example of FIG. 5) and the neighbor network nodes (e.g., base stations 502-2 and 502-3 in the example of FIG. 5) relative to the reference network node. For example, the assistance data may provide the center channel frequency of each network node, various reference signal configuration parameters (e.g., the number of consecutive positioning subframes, periodicity of positioning subframes, muting sequence, frequency hopping sequence, reference signal identifier (ID), reference signal bandwidth), a network node global ID, and/or other cell related parameters applicable to OTDOA. The OTDOA assistance data may indicate the serving cell for the UE 504 as the reference network node.

In some cases, OTDOA assistance data may also include “expected RSTD” parameters, which provide the UE 504 with information about the RSTD values the UE 504 is expected to measure at its current location between the reference network node and each neighbor network node, together with an uncertainty of the expected RSTD parameter. The expected RSTD, together with the associated uncertainty, may define a search window for the UE 504 within which the UE 504 is expected to measure the RSTD value. OTDOA assistance information may also include reference signal configuration information parameters, which allow a UE 504 to determine when a reference signal positioning occasion occurs on signals received from various neighbor network nodes relative to reference signal positioning occasions for the reference network node, and to determine the reference signal sequence transmitted from various network nodes in order to measure a signal time of arrival (ToA) or RSTD.

In an aspect, while the location server (e.g., server 400, LMF 120) may send the assistance data to the UE 504, alternatively, the assistance data can originate directly from the network nodes (e.g., base stations 502) themselves (e.g., in periodically broadcasted overhead messages, etc.). Alternatively, the UE 504 can detect neighbor network nodes itself without the use of assistance data.

The UE 504 (e.g., based in part on the assistance data, if provided) can measure and (optionally) report the RSTDs between reference signals received from pairs of network nodes. Using the RSTD measurements, the known absolute or relative transmission timing of each network node, and the known position(s) of the transmitting antennas for the reference and neighboring network nodes, the network (e.g., server 400, LMF 120, a base station 502) or the UE 504 may estimate a position of the UE 504. More particularly, the RSTD for a neighbor network node “k” relative to a reference network node “Ref” may be given as (ToAk−ToARef), where the ToA values may be measured modulo one subframe duration (1 ms) to remove the effects of measuring different subframes at different times. In the example of FIG. 5, the measured time differences between the reference cell of base station 502-1 and the cells of neighboring base stations 502-2 and 502-3 are represented as τ2-τ1 and τ3-τ1, where τ1, τ2, and τ3 represent the ToA of a reference signal from the transmitting antenna(s) of base station 502-1, 502-2, and 502-3, respectively. The UE 504 may then convert the ToA measurements for different network nodes to RSTD measurements and (optionally) send them to the server 400/LMF 120. Using (i) the RSTD measurements, (ii) the known absolute or relative transmission timing of each network node, (iii) the known position(s) of physical transmitting antennas for the reference and neighboring network nodes, and/or (iv) directional reference signal characteristics such as a direction of transmission, the UE's 504 position may be determined (either by the UE 504 or the server 400/LMF 120).

Still referring to FIG. 5, when the UE 504 obtains a location estimate using OTDOA measured time differences, the necessary additional data (e.g., the network nodes' locations and relative transmission timing) may be provided to the UE 504 by a location server (e.g., server 400, LMF 120). In some implementations, a location estimate for the UE 504 may be obtained (e.g., by the UE 504 itself or by the server 400/LMF 120) from OTDOA measured time differences and from other measurements made by the UE 504 (e.g., measurements of signal timing from global positioning system (GPS) or other global navigation satellite system (GNSS) satellites). In these implementations, known as hybrid positioning, the OTDOA measurements may contribute towards obtaining the UE's 504 location estimate but may not wholly determine the location estimate.

Uplink time difference of arrival (UTDOA) is a similar positioning method to OTDOA, but is based on uplink reference signals (e.g., sounding reference signals (SRS), uplink positioning reference signals (UL PRS), SRS for positioning signals) transmitted by the UE (e.g., UE 504). Further, transmission and/or reception beamforming at the base station 502-1, 502-2, 502-3 and/or UE 504 can enable wideband bandwidth at the cell edge for increased precision. Beam refinements may also leverage channel reciprocity procedures in 5G NR.

In NR, there is no requirement for precise timing synchronization across the network. Instead, it is sufficient to have coarse time-synchronization across gNBs (e.g., within a cyclic prefix (CP) duration of the OFDM symbols). Coarse timing synchronization is generally sufficient for Round-trip-time (RTT)-based methods, and the sidelink assisted methods described herein, and as such, are a practical positioning methods in NR.

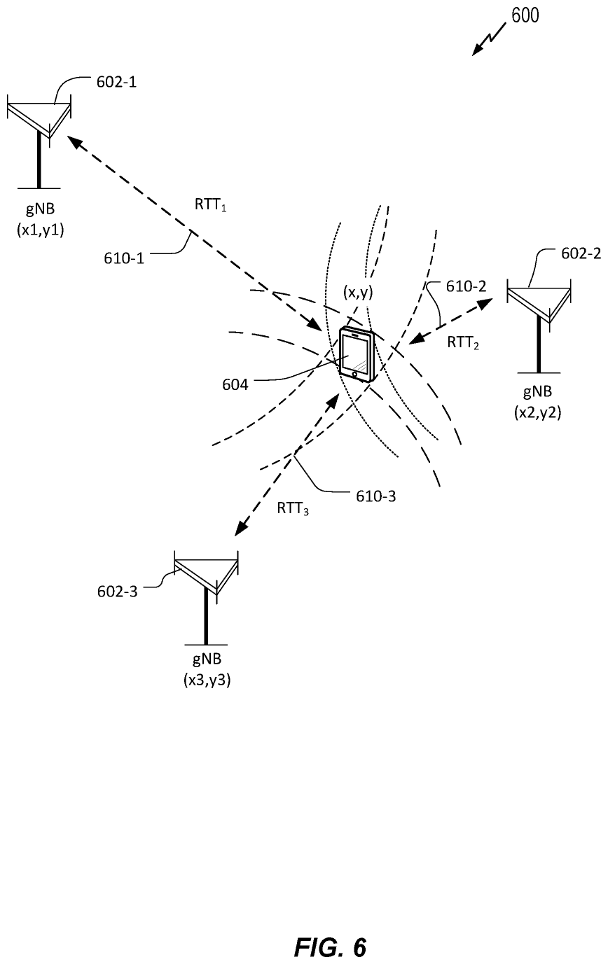

Referring to FIG. 6, an exemplary wireless communications system 600 according to aspects of the disclosure is shown. In the example of FIG. 6, a UE 604 (which may correspond to any of the UEs described herein) is attempting to calculate an estimate of its position, or assist another entity (e.g., a base station or core network component, another UE, a location server, a third party application, etc.) to calculate an estimate of its position. The UE 604 may communicate wirelessly with a plurality of base stations 602-1, 602-2, and 602-3 (which may correspond to any of the base stations described herein) using RF signals and standardized protocols for the modulation of the RF signals and the exchange of information packets. By extracting different types of information from the exchanged RF signals, and utilizing the layout of the wireless communications system 600 (i.e., the base stations' locations, geometry, etc.), the UE 604 may determine its position, or assist in the determination of its position, in a predefined reference coordinate system. In an aspect, the UE 604 may specify its position using a two-dimensional coordinate system; however, the aspects disclosed herein are not so limited, and may also be applicable to determining positions using a three-dimensional coordinate system, if the extra dimension is desired. Additionally, while FIG. 6 illustrates one UE 604 and three base stations 602-1, 602-2, 602-3, as will be appreciated, there may be more UEs 604 and more base stations.

To support position estimates, the base stations 602-1, 602-2, 602-3 may be configured to broadcast reference RF signals (e.g., PRS, NRS, CRS, TRS, CSI-RS, PSS, SSS, etc.) to UEs 604 in their coverage area to enable a UE 604 to measure characteristics of such reference RF signals. For example, the UE 604 may measure the ToA of specific reference RF signals (e.g., PRS, NRS, CRS, CSI-RS, etc.) transmitted by at least three different base stations and may use the RTT positioning method to report these ToAs (and additional information) back to the serving base station (e.g., base station 602-2) or another positioning entity (e.g., server 400, LMF 120).

In an aspect, although described as the UE 604 measuring reference RF signals from a base station 602-1, 602-2, 602-3, the UE 604 may measure reference RF signals from one of multiple cells supported by a base station 602-1, 602-2, 602-3. Where the UE 604 measures reference RF signals transmitted by a cell supported by a base station 602-2, the at least two other reference RF signals measured by the UE 604 to perform the RTT procedure would be from cells supported by base stations 602-1, 602-3 different from the first base station 602-2 and may have good or poor signal strength at the UE 604.

In order to determine the position (x, y) of the UE 604, the entity determining the position of the UE 604 needs to know the locations of the base stations 602-1, 602-2, 602-3, which may be represented in a reference coordinate system as (xk, yk), where k=1, 2, 3 in the example of FIG. 6. Where one of the base stations 602-2 (e.g., the serving base station) or the UE 604 determines the position of the UE 604, the locations of the involved base stations 602-1, 602-3 may be provided to the serving base station 602-2 or the UE 604 by a location server with knowledge of the network geometry (e.g., server 400, LMF 120). Alternatively, the location server may determine the position of the UE 604 using the known network geometry.

Either the UE 604 or the respective base station 602-1, 602-2, 602-3 may determine the distance (dk, where k=1, 2, 3) between the UE 604 and the respective base station 602-1, 602-2, 602-3. In an aspect, determining the RTT 610-1, 610-2, 610-3 of signals exchanged between the UE 604 and any base station 602-1, 602-2, 602-3 can be performed and converted to a distance (dk). RTT techniques can measure the time between sending a signaling message (e.g., reference RF signals) and receiving a response. These methods may utilize calibration to remove any processing and hardware delays. In some environments, it may be assumed that the processing delays for the UE 604 and the base stations 602-1, 602-2, 602-3 are the same. However, such an assumption may not be true in practice.

Once each distance dk is determined, the UE 604, a base station 602-1, 602-2, 602-3, or the location server (e.g., server 400, LMF 120) can solve for the position (x, y) of the UE 604 by using a variety of known geometric techniques, such as, for example, trilateration. From FIG. 6, it can be seen that the position of the UE 604 ideally lies at the common intersection of three semicircles, each semicircle being defined by radius dk and center (xk, yk), where k=1, 2, 3.

In some instances, additional information may be obtained in the form of an angle of arrival (AoA) or angle of departure (AoD) that defines a straight line direction (e.g., which may be in a horizontal plane or in three dimensions) or possibly a range of directions (e.g., for the UE 604 from the location of a base station 602-1, 602-2, 602-3). The intersection of the two directions at or near the point (x, y) can provide another estimate of the location for the UE 604.

A position estimate (e.g., for a UE 604) may be referred to by other names, such as a location estimate, location, position, position fix, fix, or the like. A position estimate may be geodetic and comprise coordinates (e.g., latitude, longitude, and possibly altitude) or may be civic and comprise a street address, postal address, or some other verbal description of a location. A position estimate may further be defined relative to some other known location or defined in absolute terms (e.g., using latitude, longitude, and possibly altitude). A position estimate may include an expected error or uncertainty (e.g., by including an area or volume within which the location is expected to be included with some specified or default level of confidence).

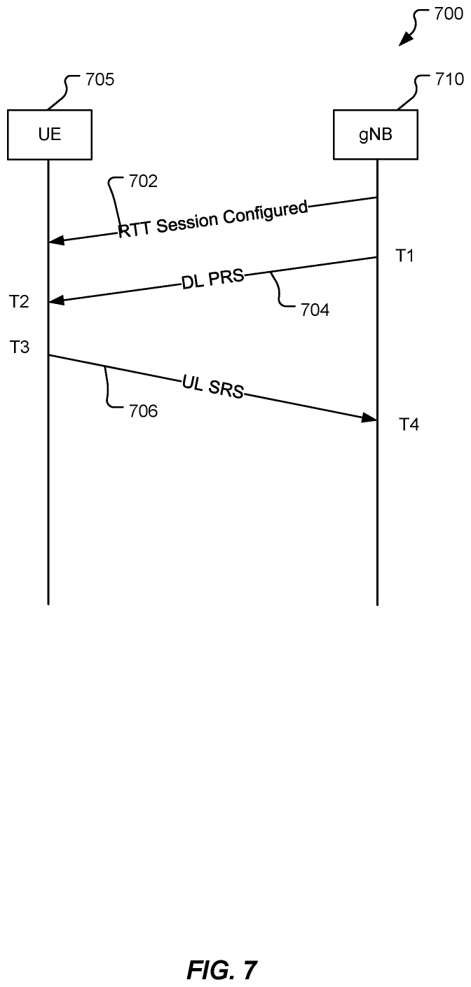

Referring to FIG. 7, an example round trip message flow 700 between two wireless nodes such as a user equipment 705 and a base station 710 is shown. The UE 705 is an example of the UE 105, 200 and the base station 710 may be a gNB 110a-b or ng-eNB 114. In general, RTT positioning methods utilize a time for a signal to travel from one entity to another and back to determine a range between the two entities. The range, plus a known location of a first one of the entities and an angle between the two entities (e.g., an azimuth angle) can be used to determine a location of the second of the entities. In multi-RTT (also called multi-cell RTT), multiple ranges from one entity (e.g., a UE) to other entities (e.g., TRPs) and known locations of the other entities may be used to determine the location of the one entity. The example message flow 700 may be initiated by the base station 710 with a RTT session configure message 702. The base station may utilize the LPP/NRPPa messaging to configure the RTT session. At time T1, the base station 710 may transmit a DL PRS 704, which is received by the UE 705 at time T2. In response, the UE 705 may transmit a Sounding Reference Signal (SRS) for positioning message (e.g., UL-SRS) 706 at time T3 which is received by the base station 710 at time T4. The distance between the UE 705 and the base station 710 may be computed as:

$$distance = \frac{c}{2} ( ( T 4 - T 1 ) - ( T 3 - T 2 ) ) where c = speed of light . \qquad ( 1 )$$

In operation, the accuracy of the distance measurement, and a corresponding position estimate, are based on the known location of one of the two stations (e.g., UE 705 or the base station 710).

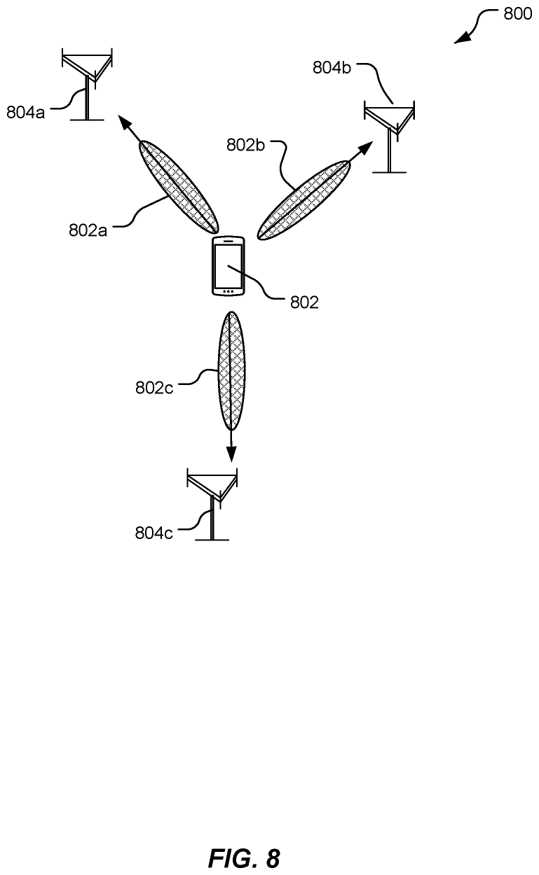

Referring to FIG. 8, a diagram 800 of uplink positioning reference signals is shown. The diagram 800 includes a UE 802 and a plurality of base stations including a first base station 804a, a second base station 804b, and a third base station 804c. The UE 802 may have some or all of the components of the UE 200, and the UE 200 may be an example of the UE 802. Each of the base stations 804a-c may have some or all of the components of the TRP 300, and the TRP 300 may be an example of one or more of the base stations 804a-c. In operation, the UE 802 may be configured to transmit one or more reference signals such as a first reference signal 802a, a second reference signal 802b, and a third reference signal 802c. The reference signals 802a-c may be UL PRS or SRS for positioning signals which may be received by one or more of the base stations 804a-c. While the diagram 800 depicts three reference signals, few or more reference signals may be transmitted by the UE 802 and detected by one or more neighboring stations. In an example, the reference signals 802a-c may be SRS for positioning signals. In general, SRS for positioning signals in NR may be UE configured reference signals transmitted by a UE and used for the purpose of determining a range between the UE and one or more receiving stations such as the base stations 804a-c, or another UE (e.g., via a sidelink transmitted SRS). SRS may also be used for the purpose of sounding an uplink radio channel. The reference signals 802a-c may be SRS for positioning resources included in a SRS for positioning resource set. The SRS for positioning resource set may be used to enable activation for semi-persistent SRS and aperiodic SRS (e.g., via DCI triggering), and multiple SRS resources for positioning may be activated simultaneously.

Current SRS configurations are cell-specific and configured by a base station (e.g., gNB) specifically for a UE. The UE must therefore suspend SRS transmissions when it moves across cells. The techniques provided herein may define a common SRS configuration that is valid for a group of cells. This configuration may be valid even if the UE moves across cells within a group, and a UE may transmit the SRS even when there is a cell change as long as it is within the defined group of cells. The UE may also be configured to record and report Rx-Tx values when it has access to the associated uplink resources. When the UE moves out of the coverage of the defined group of cells, it may be configured to connect to the network and obtain a new SRS configuration.

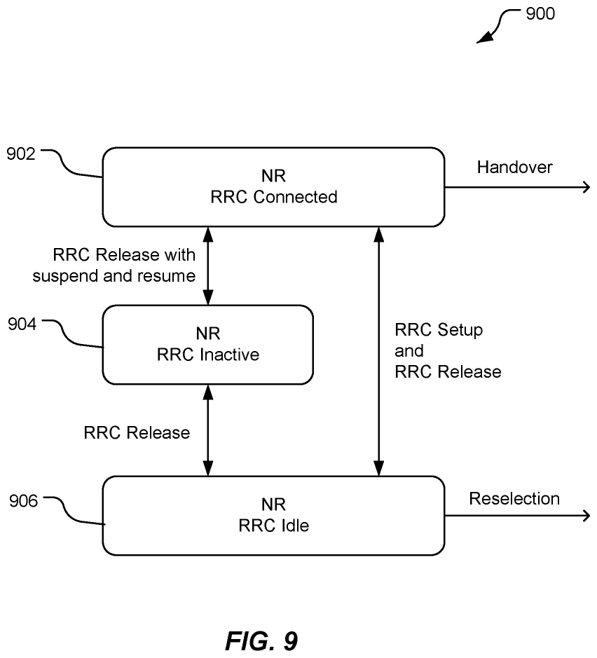

Referring to FIG. 9, a diagram 900 of example RRC state transitions is shown. In general, a UE such as the UE 200, may start in an RRC idle mode 906 when it first camps on a cell (e.g., when the UE is first powered on). The UE may transition from the RRC idle mode 906 to a RRC connected mode 902 by completing a RRC setup procedure. An RRC connection is a logical connection between the UE and a base station (e.g., gNB). While in the RRC connected mode 902, the UE may register with the cellular network. In an example, the UE may transition from the RRC connected mode 902 to a RRC inactive mode 904 using an RRC release procedure. In an example, a suspend configuration parameter may be included in a RRC release message to indicate that the UE is being transitioned to the RRC inactive mode 904 rather than the RRC idle mode 906. A UE in the RRC inactive mode 904 may return to the RRC connected mode 902 to transfer application data or signaling messages with a reduced latency. In an example, a UE maybe configured to perform cell reselection procedures while in the RRC inactive mode 904 and/or the RRC idle mode 906. Cell level handover procedures may involve RRC signaling to the UE while in the RRC connected mode 902. A base station (e.g., gNB) may provide a UE with thresholds for various reporting events, and the UE may utilize the reporting events to trigger the transmission of measurement reports. The uplink positioning methods provided herein may be utilized with both cell reselection and cell handover procedures.

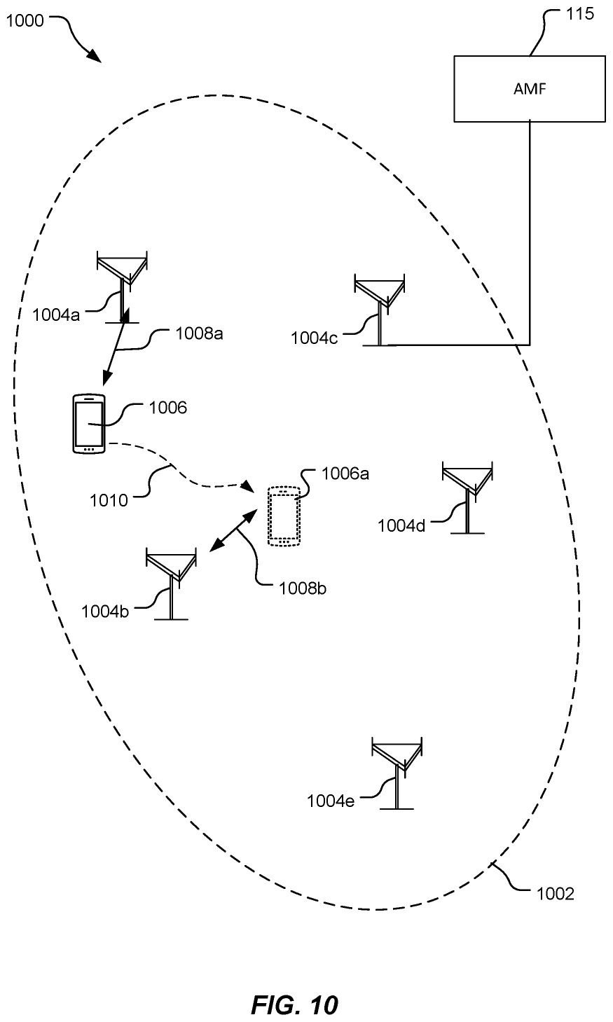

Referring to FIG. 10, a diagram 1000 of an example RAN notification area (RNA) 1002 is shown. The RNA 1002 includes a set of cells 1004a-1004e which may be defined by a network entity such as the AMF 115 and provided to a UE 1006 as a list of cell identities. Each of the cells 1004a-1004e are interconnected via Xn interfaces (not shown in FIG. 10). The UE 1006 may complete a cell reselection procedure with the cells in the RNA 1002 while in the RRC inactive mode 904. For example, the UE 1006 may be camped on a first cell 1004a and may monitor channels via a first wireless link 1008a. The UE 1006 may move along a trajectory 1010 to a second position 1006a and monitor a second wireless link 1008b while in the RRC inactive mode 904. For example, the UE 1006 may be configured to receive RNA configuration information via a System Information Block (SIB), or other transmissions from a target cell 1004b to determine if the target cell 1004b is included in the RNA 1002. If another target cell is outside of the RNA 1002, the UE 1006 would be required to re-enter the RRC connected mode 902 to inform the network that it has left the RNA 1002.

In an example, the RNA 1002 information may include SRS configuration information to enable the UE 1006 to transmit an SRS to the cells in the RNA 1002 (e.g., cells 1004a-1004e). The UE 1006 may be configured to perform an RNA Update (RNAU) procedure when it changes its current RNA to receive new RNA information from the network. SRS configuration information may also be signaled in this new RNAU configuration when the UE 1006 is in the RRC inactive mode 904. In an example, a serving cell may be configured to update the SRS configuration and the list of valid cells at any time when the UE 1006 is in the RRC connected mode 902. In an example, a group of cells within the RNA, or group of cell intersecting with the group of cells in the RNA may be identified in the RNAU and/or list of valid cells, and associated with a group SRS configuration. A base station may be configured to provide the group SRS configuration to neighboring cells and/or to a network resource (e.g., LMF 120) to propagate the list of cells and associated SRS configuration.

In LTE systems, a group of neighboring cells may be associated with a tracking area (TA) and a UE may receive a tracking area identifier (TAI) list when it connects to a network. The UE may also send a tracking area update (TAU) procedure when it moves into a new TA. In an example, SRS configuration information may be associated with a TA and the UE may be configured to use the same SRS configuration for each cell in a TA.

In an example, the SRS configuration may be associated with a Bandwidth Part (BWP) and a new cell may be configured to maintain or update the BWP configuration once a UE has completed a handover procedure.

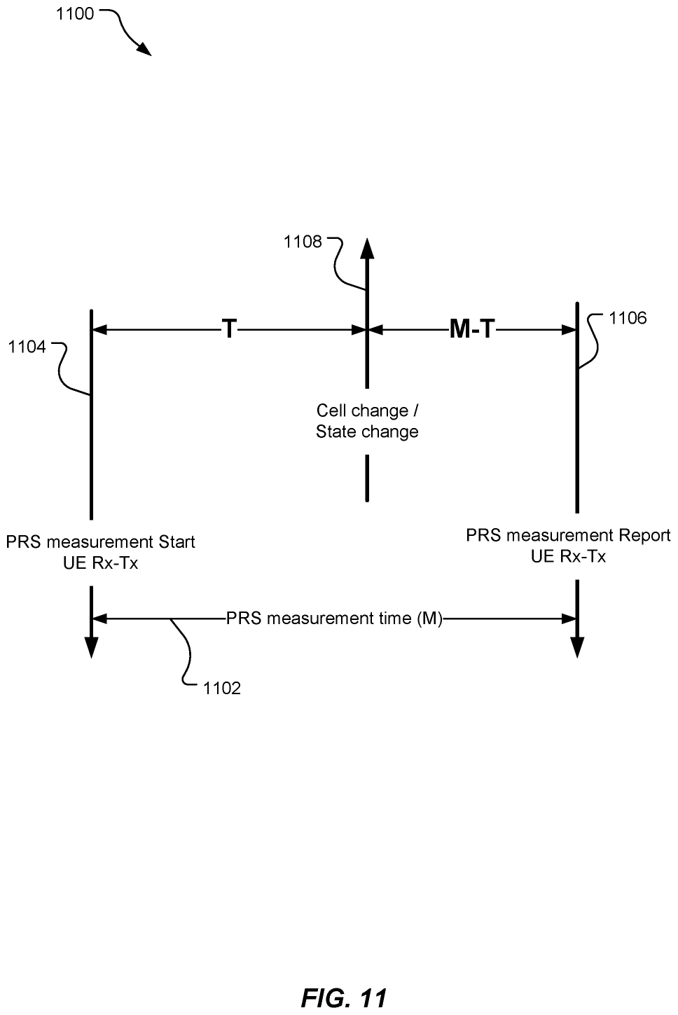

Referring to FIG. 11, a timing diagram of an example cell change during a positioning session 1100 is shown. The positioning session 1100 may be, for example, PRS measurement exchanges such as described in FIG. 7 and may have a session duration of time M 1102. The positioning session 1100 may begin at a PRS measurement start time 1104 and end at a PRS measurement report time 1106. A cell handover or reselection procedure 1108 between a first cell and a second cell may occur during the positioning session 1100 (e.g., between the start time 1104 and the report time 1106). In prior approaches, a UE would suspend the positioning session 1100 when the cell handover or reselection procedure 1108 occurs because the SRS configurations would change between the first cell and the second cell. The techniques provided herein establish a SRS configuration for the first and second cell and thus enable the positioning session 1100 to continue through the cell handover or reselection procedure 1108.

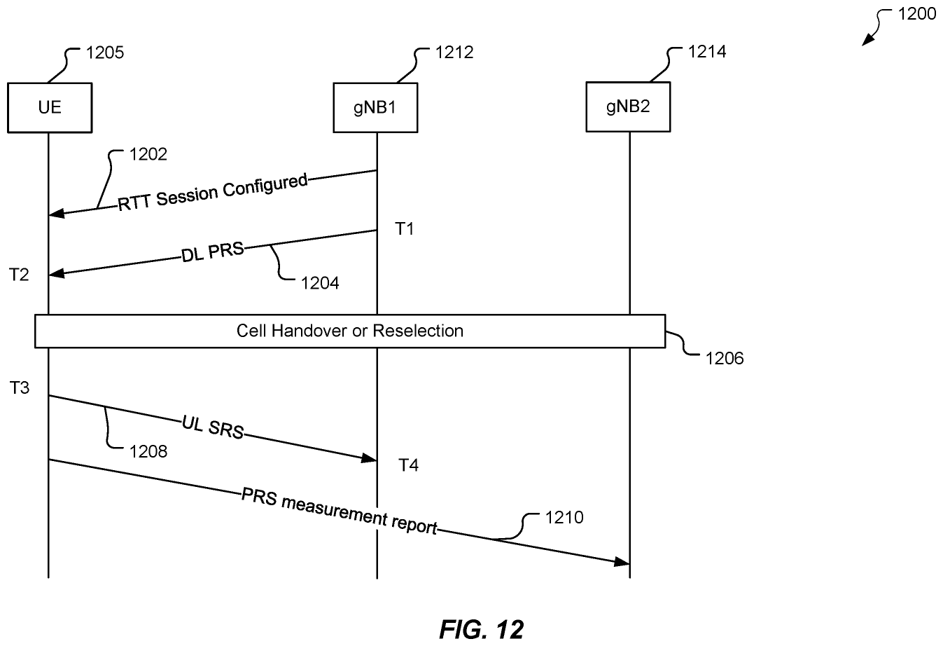

Referring to FIG. 12, an example positioning measurement message flow 1200 with a cell handover or reselection procedure is shown. The message flow 1200 includes a UE 1205, a first gNB 1212, and a second gNB 1214. The UE 1205 may include some or all of the components of the UE 200, and the UE 200 is an example of the UE 1205. The gNBs 1212, 1214 may include some or all of the components of the TRP 300, and the TRP 300 is an example of the gNBs 1212, 1214. The gNBs 1212, 1214 are in a group of stations, such as the RNA 1002, and are configured to utilize an SRS configuration within the group. The example message flow 1200 may be initiated by the first gNB 1212 with a RTT session configure message 1202. An LMF 120 (not shown in FIG. 12) may utilize the LPP/NRPPa messaging to configure the RTT session via the first gNB 1212. At time T1, the first gNB 1212 may transmit one or more DL PRS 1204, which are received by the UE 1205 at time T2. During the positioning session, for example such as after the DL PRS 1204 have been transmitted, the UE 1205 may perform a cell handover or reselection procedure 1206 with the first and second gNBs 1212, 1214. In an example, the UE 1205 may transmit a SRS for positioning message (e.g., UL-SRS) 1208 at time T3 which is received by the first gNB 1212 at time T4. The UE 1205 may provide a PRS measurement report 1210 to the second gNB 1214 (i.e., the new serving cell). The timing of the cell handover or reselection procedure 1206 in the message flow 1200 is an example, and not a limitation, as the cell handover or reselection procedure 1206 could occur at other times between the session configuration message 1202 and the measurement report 1210.

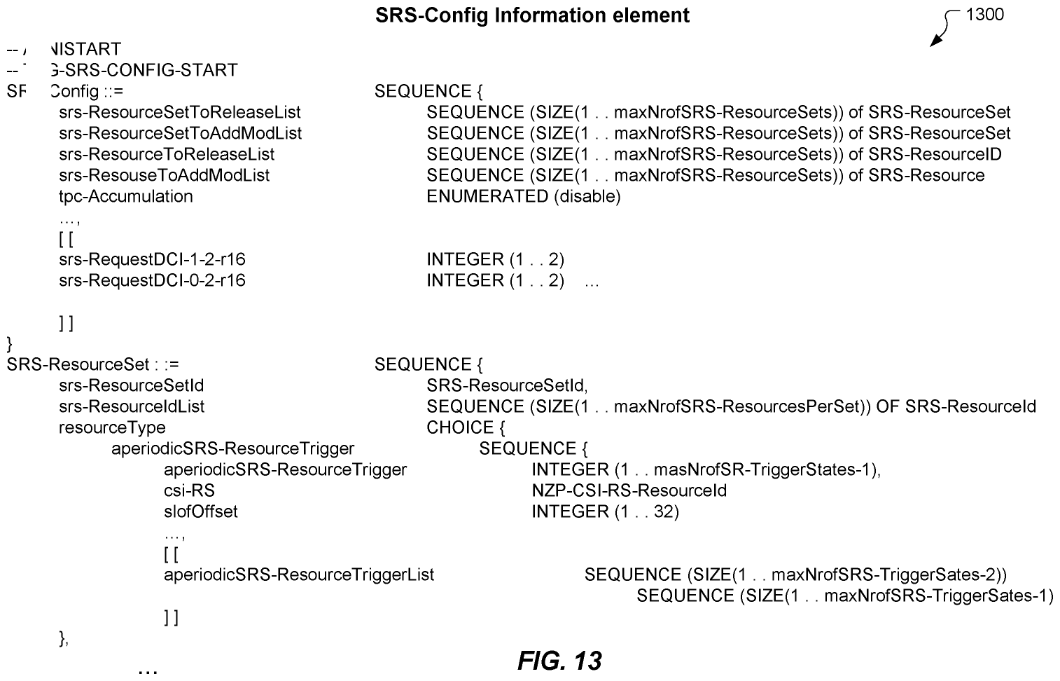

Referring to FIG. 13, a portion of an example SRS configuration information element 1300 is shown. The SRS configuration may be based on existing industry standards such as 3GPP TS 38.331 V16 and may be provided to cells in a group of cells, such as a RNA. In an example, the SRS configuration information element 1300 may be included in a RNAU and provided to UEs upon entering the RNA. Other groups of cells may also be defined. The SRS configuration information element 1300 may be used by the UE for each cell in the group of cells, and thus the UE may continue a positioning session when a handoff or reselection procedure occurs between the cells in the group of cells. The SRS configuration element 1300 is an example, and not a limitation, as other configuration information may be provided to the group of cells.

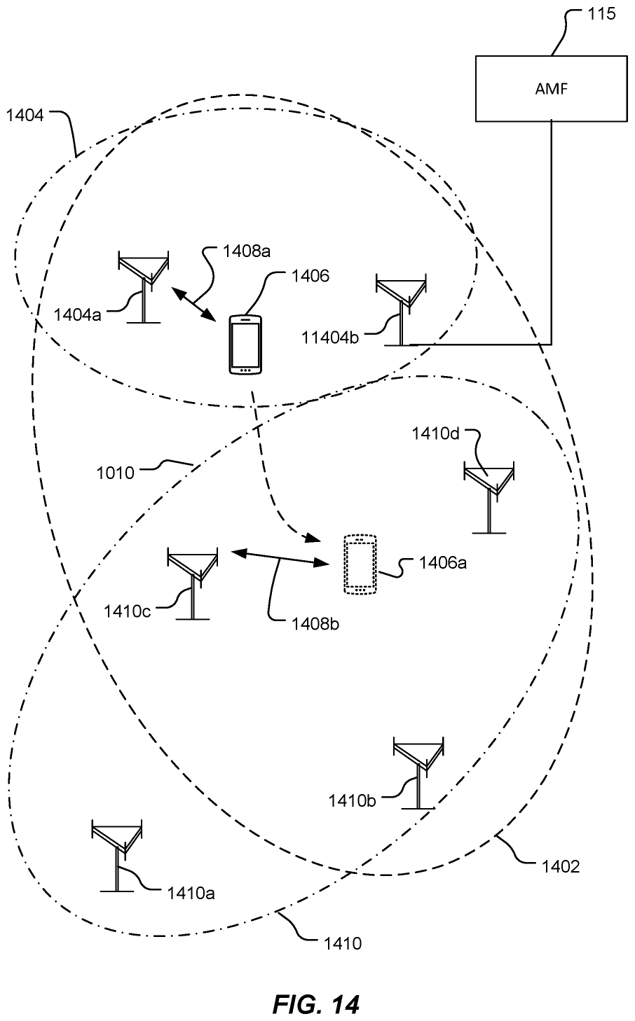

Referring to FIG. 14, examples of an RNA and common cell groups are shown. An RNA 1402 may include a plurality of cells such as a first cell 1404a, a second cell 1404b, a third cell 1410b, a fourth cell 1410c, and a fifth cell 1410d. The number and locations of the plurality of cells in the RNA 1402 may vary within a network. In an example, as discussed in FIG. 10, the RNA 1402 may be a group a cells configured to utilize a common SRS configuration which is provided via an RNAU procedure. Other groups of cells which are not dependent on the RNA structure may also be defined by a network resource such as the AMF 115 and/or the LMF 120. The groups of cells may be a subset of an RNA and/or may include cells outside of an RNA (e.g., the group of cells may intersect with the RNA). For example, a first group of cells 1404 may include the first cell 1404a and the second cell 1404b, and a second group of cells 1410 may include the third cell 1410b, the fourth cell 1410c, the fifth cell 1410d, and a sixth cell 1410a. In operation, a first SRS configuration may be associated with the cells in the first group of cells 1404, and a second SRS configuration may be associated with the cells in the second group of cells 1410. The respective SRS configurations are valid when a UE moves across cells within a group. For example, a UE 1406 could transmit the same SRS configuration to the first cell 1404a and the second cell 1404b (i.e., the cells in the first group of cells 1404). The UE 1406 may also be configured to record and report Rx-Tx values when it has access to UL resources, such as a first communication link 1408a. In an example, the UE 1406 may move to a new position 1406a, which is away from the first group of cells 1404 and within the coverage area of the second group of cells 1410. The UE 1406 may connect to the network via a second communication link 1408b with the fourth cell 1410c and receive a new SRS configuration and a list of cells in the second group of cells 1410. In an example, the UE 1406 may enter the RRC connected mode 902 and receive the new SRS configuration and cell list information from the new serving cell.

In an example, the UE 1406 may be configured to receive SRS configuration information in response to a cell handover or reselection procedure during a positioning session, irrespective of the cell list and/or RNA information. The UE 1406 may be in the RRC inactive mode 904 and may perform a reselection procedure with a cell in the cell list and/or RNA information without receiving new SRS configuration when the reselection procedure is not concurrent with a positioning session. The reduction in signaling provides power savings as compare to prior methods when SRS configurations are provided with each cell handover. When the UE 1406 performs a cell reselection within a positioning session, however, the UE 1406 may be configured to request an RNA update, or other requests, to obtain SRS configuration and cell list information from the new serving cell. The additional signaling may require additional power consumption but provides the benefit of ensuring the UE 1406 has the SRS configuration from the new serving cell.

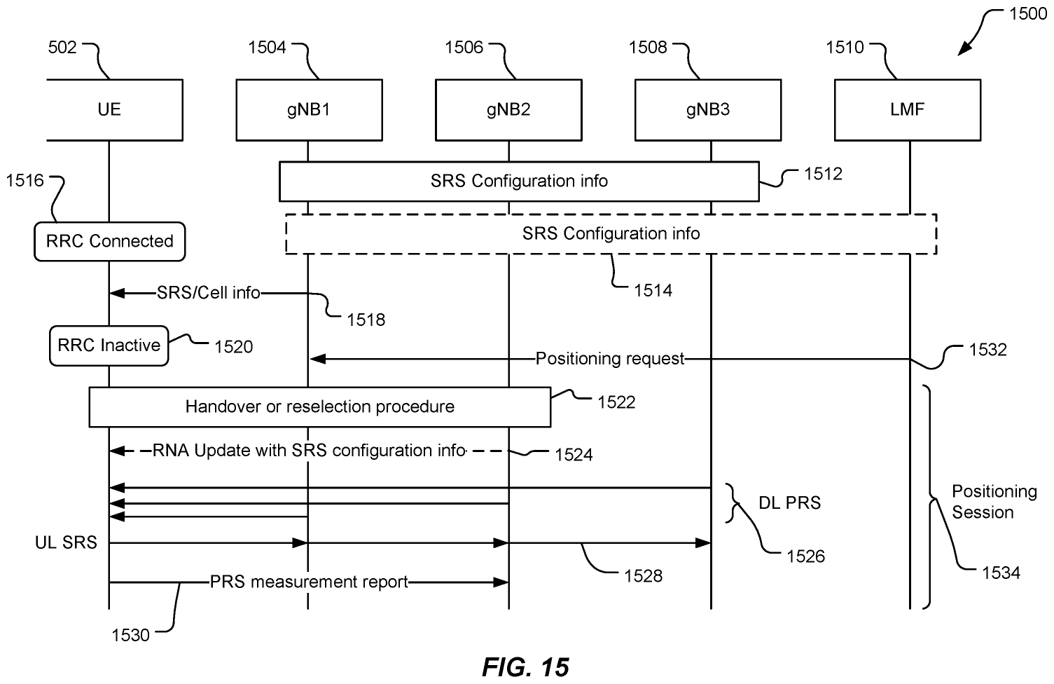

Referring to FIG. 15, an example message flow 1500 for uplink positioning methods during handover or cell reselection procedures is shown. The flow 1500 includes elements of the communication system 100 such as a UE 1502 and a plurality of cells including a first gNB 1504, a second gNB 1506, and a third gNB 1508. The gNBs 1504, 1506, 1508 are members of a group of cells such as an RNA 1002, or the first and second groups of cells 1404, 1410 depicted in FIG. 14. The message flow 1500 also includes one or more network resources, such as the LMF 1510 which is configured to communicate with UEs and gNBs in the network. In an example, the gNBs 1504, 1506, 1508 may be configured to provide SRS configuration information to one another via Xn connections at stage 1512. The LMF 120 may also be configured to provide the SRS configuration information at stage 1514 via LPP/NRPPa messaging protocols. The SRS configuration information may be the SRS configuration information elements 1300, or other formatted messages to define a SRS resource or resource set. The UE 1502 may be in an RRC connected mode at stage 1516 with the first gNB 1504 as a serving cell. The first gNB 1504 may be configured to provide SRS configuration and cell information to identify a group of cells or RNA (e.g., the gNBs 1504, 1506, 1508) via one or more configuration messages 1518. The configuration messages 1518 may utilize RRC or other over-the-air (OTA) signaling techniques.

At a subsequent time, the UE 1502 may enter a RRC inactive mode at stage 1520 and monitor signals from one or more gNBs. The LMF 1510, or other network entity including the UE 1502, may request positioning information for the UE 1502. In an example, the LMF 1510 may provide a positioning request message 1532 to the first gNB 1504 (i.e., the serving cell) to obtain positioning measurements for the UE 1502. A positioning session 1534 may be initiated for the UE 1502. In an example, the positioning session 1534 may be a multi-RTT session based on DL PRS and UL SRS signals transmitted and received by the gNBs 1504, 1506, 1508. Subsequent to the initiation of the positioning session 1534, the UE 1502 may move to the coverage area of the second gNB 1506 and a handover or reselection procedure may be performed at stage 1522. The UE 1502 may utilize the SRS configuration information obtained when the UE 1502 first entered the group of cells (e.g., the configuration messages 1518). In an example, the new serving cell (e.g., the second gNB 1506) may be configured to optionally provide an RNA update 1524 with the SRS configuration information in response to the handover or reselection procedure. The gNBs 1504, 1506, 1508 are configured to transmit DL PRS 1526 which are received and measured by the UE 1502. The UE 1502 is configured to transmit one or more UL SRS 1528 based on the SRS configuration information, which are received by the gNBs 1504, 1506, 1508. The UE 1502 may provide one or more PRS measurement reports 1530 to the new serving cell (e.g., gNB 1506) based on the DL PRS 1526 and the UL SRS 1528. For example, the PRS measurement reports 1530 may include Rx-Tx information obtained by the UE 1502. In an example, the PRS measurement reports 1530 may be provided to the LMF 1510, and the LMF 1510 may be configured to determine the location of the UE 1502 based on the PRS measurements.

While the handover or reselection procedure at stage 1522 occurs at the beginning of the positioning session 1534 in the message flow 1500, the disclosure is not so limited. The handover or reselection procedure at stage 1522 may occur at other times within the positioning session 1534 and the UE 1502 may utilize the same SRS configuration for the UL SRS 1528.

In an example, the SRS transmission may utilize open-loop power control based on the received downlink signals. Since the same SRS configuration is available in the group of cells (e.g., gNBs 1504, 1506, 1508), the UE 1502 may have different options for selecting a cell DL path loss to use for SRS transmission. One option may be to utilize DL signals transmitted from the current serving cell to determine path loss power. The DL signals may include the PRS 1526, and/or other signals such as SSB, TRS, etc. In an example, the UE 1502 may utilize DL signals transmitted from a new serving cell to determine the DL path loss (e.g., after a handover or reselection procedure). In an option, the UE 1502 may utilize signals transmitted from a cell which transmitted first during a positioning session. For example, the UE 1502 may measure the first DL PRS 1526, which is transmitted by the third gNB 1506 to determine the path loss power. In an option, one specific cell within a RNA may be used to as the positioning SRS path reference. In one option, the UE 1502 may measure multiple cells DL path loss reference signals and select the cell with the lowest path loss. This lowest path loss will be used as the positioning SRS path reference. Similar techniques may also be used for the spatial relation indication for the SRS.

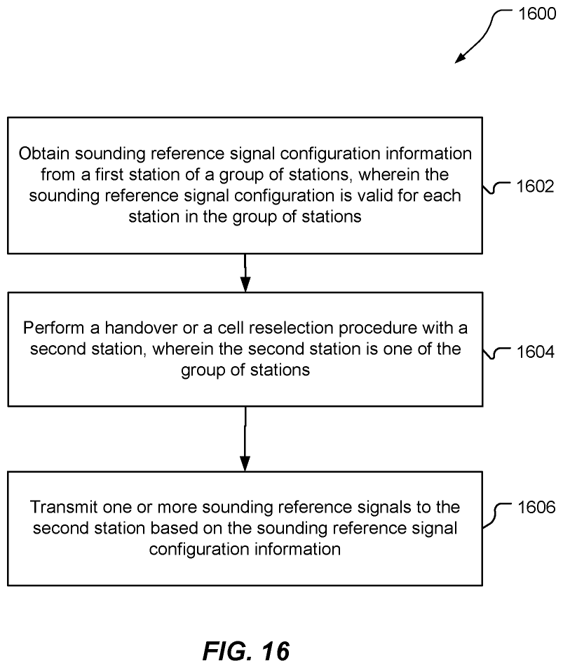

Referring to FIG. 16, with further reference to FIGS. 1-15, a method 1600 for transmitting sounding reference signals includes the stages shown. The method 1600 is, however, an example and not limiting. The method 1600 may be altered, e.g., by having stages added, removed, rearranged, combined, performed concurrently, and/or having single stages split into multiple stages.

At stage 1602, the method includes obtaining sounding reference signal configuration information from a first station of a group of stations, wherein the sounding reference signal configuration is valid for each station in the group of stations. A UE 200, including processor 210 and a transceiver 215, is a means for obtaining SRS configuration information. In an example, the UE 200 may be in a RRC connected mode 902 or the RRC inactive mode 904 and may receive SRS configuration information via RRC signaling such as via a SIB, or other transmissions from a serving cell. The SRS configuration information may be utilized by each station in the group of stations (e.g., the stations on a defined list), and each station may be configured to receive SRS transmissions based on the SRS configuration information. In an example, the group of cells may be a RNA 1002 and the SRS configuration information may be included during a RNAU procedure with a new serving cell. In an example, the SRS configuration may be received from a network resource, such as the LMF 120, via LPP or other messaging protocols. The SRS configuration information may be a SRS resource, such as the SRS configuration information element 1300.

At stage 1604, the method includes performing a handover or a cell reselection procedure with a second station, wherein the second station is one of the group of stations. The processor 210 and the transceiver 215 are means for performing a handover or a cell reselection procedure. The handover or cell reselection procedure may be based on industry standards such as 3GPP TS 38.304. In an example, the UE 200 may be configured to perform an Xn based handover procedure to allow the primary serving cell to be change from one base station to another base station, when the base stations are connected using an Xn interface. An N2 based handover procedure may be used when the Xn interface is not available. In an example, when the UE 200 is in an RRC connected mode 902, the UE 200 may trigger the handover procedure by sending an RRC measurement report to the first station. In an example, the first station may be configured to trigger the handover procedure. The UE 200 may utilize a cell reselection procedure when in the RRC inactive mode 904 or the RRC idle mode 906. The UE 200 may be configured to measure the signal energy (e.g., cell power) for neighboring cells to detect a strong signal (e.g., the strongest of the received signals and/or above an established threshold). A SIB transmitted from the second station may include reselection parameters to enable the UE 200 to register with the second station. Other signaling may also be used to enable the UE 200 to change the current serving cell from the first station to the second station.

At stage 1606, the method includes transmitting one or more sounding reference signals to the second station based on the sounding reference signal configuration information. The processor 210 and the transceiver 215 are means for transmitting one or more SRS. The UE 200 is configured to transmit SRS to the cells in the group of cells (e.g., the first and second stations) based on the same SRS configuration. The method 1600 enables a UE to utilize a single SRS configuration (i.e., the SRS configuration received at stage 1602) with multiple cells and thus allows positioning measurements to continue through a handover or reselection procedure.

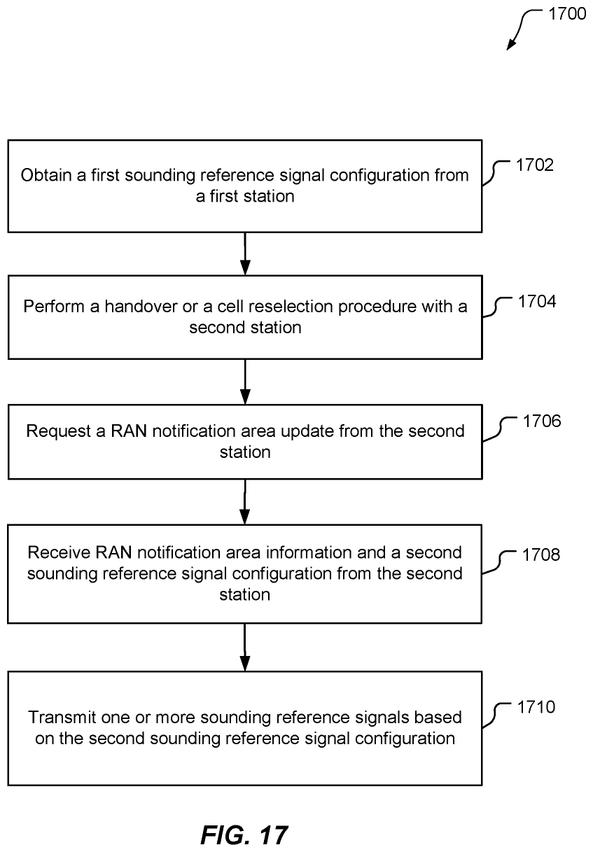

Referring to FIG. 17, with further reference to FIGS. 1-15, a method 1700 for transmitting sounding reference signals with a handover or cell reselection procedure includes the stages shown. The method 1700 is, however, an example and not limiting. The method 1700 may be altered, e.g., by having stages added, removed, rearranged, combined, performed concurrently, and/or having single stages split into multiple stages.

At stage 1702, the method includes obtaining a first sounding reference configuration from a first station. A UE 200, including processor 210 and a transceiver 215, is a means for obtaining the first SRS configuration. In an example, the UE 200 may be in a RRC connected mode 902 or the RRC inactive mode 904 and may receive a SRS configuration via RRC signaling such as via a SIB, or other transmissions from a serving cell. In an example, the SRS configuration may be received from a network resource, such as the LMF 120, via LPP or other messaging protocols. The first SRS configuration may be a SRS resource, such as the SRS configuration information element 1300.

At stage 1704, the method includes performing a handover or a cell reselection procedure with a second station. The processor 210 and the transceiver 215 are means for performing a handover or a cell reselection procedure. The handover or cell reselection procedure may be based on industry standards such as 3GPP TS 38.304. In an example, the UE 200 may be configured to perform an Xn based handover procedure to allow the primary serving cell to be change from one base station to another base station, when the base stations are connected using an Xn interface. An N2 based handover procedure may be used when the Xn interface is not available. In an example, when the UE 200 is in an RRC connected mode 902, the UE 200 may trigger the handover procedure by sending an RRC measurement report to the first station. In an example, the first station may be configured to trigger the handover procedure. The UE 200 may utilize a cell reselection procedure when in the RRC inactive mode 904 or the RRC idle mode 906. The UE 200 may be configured to measure the signal energy (e.g., cell power) for neighboring cells to detect a strong signal (e.g., the strongest of the received signals and/or above an established threshold). A SIB transmitted from the second station may include reselection parameters to enable the UE 200 to register with the second station. Other signaling may also be used to enable the UE 200 to change the current serving cell from the first station to the second station.

At stage 1706, the method includes requesting a RAN notification area update from the second station. The processor 210 and the transceiver 215 are means for requesting the RNAU. In an example, a UE 200 may be configured to perform an RNAU procedure when it changes its current RNA to receive new RNA information from the network. The UE 200 may send one or more RNAU messages periodically or when the UE 200 selects a cell that does not belong to the configured RNA. Other messaging may also be used to request RAN information (i.e., 3GPP TS 38.304 V16).

At stage 1708, the method includes receiving RAN notification area information and a second sounding reference signal configuration from the second station. The processor 210 and the transceiver 215 are means for receiving the RNA information and the second SRS configuration. In response to the RNAU messages sent at stage 1706, the second station may provide a list of cells for a new RNA and an associated SRS configuration to be used with the RNA. In general, the RNAU procedure may occur when the UE 200 is in the RRC inactive mode 904. In an example, a serving cell may be configured to update the SRS configuration and the list of valid cells at any time when the UE 200 is in the RRC connected mode 902.

At stage 1710, the method includes transmitting one or more sounding reference signals to the second station based on the sounding reference signal configuration. The processor 210 and the transceiver 215 are means for transmitting one or more SRS. The UE 200 is configured to transmit SRS to the cells in the RNA based on the same SRS configuration. The method 1700 enables the UE 200 to utilize a single SRS configuration with each of the cells in the RNA and thus enables positioning measurements to continue through a handover or reselection procedure.

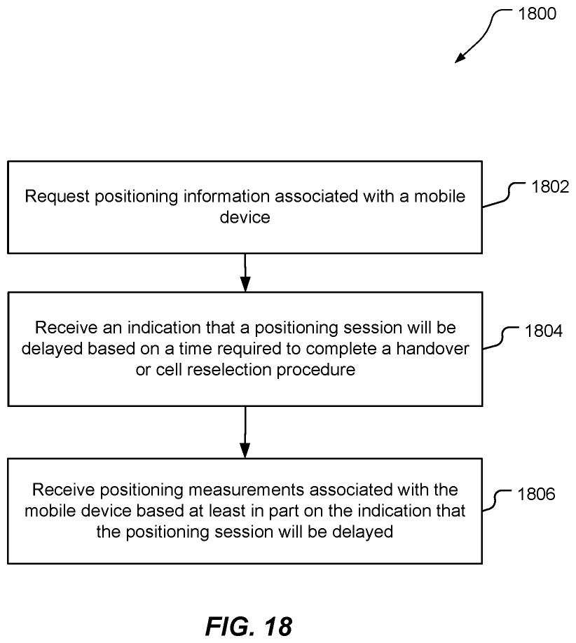

Referring to FIG. 18, with further reference to FIGS. 1-15, a method 1800 for delaying a positioning session based on a handover or cell reselection procedure includes the stages shown. The method 1800 is, however, an example and not limiting. The method 1800 may be altered, e.g., by having stages added, removed, rearranged, combined, performed concurrently, and/or having single stages split into multiple stages.

At stage 1802, the method includes requesting positioning information associated with a mobile device. A server 400, such as the LMF 120 including a processor 410 and a transceiver 415, is a means for requesting positioning information. In an example, the LMF 120 or other network entities may request positioning information for a mobile device, such as the UE 200. The LMF 120 may communicate with the AMF 115 (e.g., via one or more LPP/NPP messages) to obtain information for scheduling a positioning session for the mobile device. In an example, the LMF 120 may query the AMF 115 for location information associated with the mobile device, and the AMF 115 may respond with an indication that a positioning session will be delayed by T seconds due to a pending or an active handover or cell reselection procedure.

At stage 1804, the method includes receiving an indication that a positioning session will be delayed based on a time required to complete a handover or cell reselection procedure. The processor 410 and transceiver 415 are means for receiving an indication the that the positioning session will be delayed. In an example, the AMF 115 may receive a NGAP path switch request from a new serving base station to indicate that the mobile device is in the process of a handover or cell reselection procedure. The AMF 115 may provide a NGAP path switch response to the new serving base station and forecast when the handover or cell reselection procedure will be completed. In an example, the forecasted delay may be based on a default time value (e.g., 0.5, 1, 2, 5, etc. seconds). The delay time may be based on expected or historical handover time information. For example, the previous durations between XnAP receive UE context request and XnAP UE context release messages between the old and new serving cells may be used to forecast a delay time. The LMF 120 may receive the forecast delay time (e.g., a duration time T) from the AMF 115 indicating how long the positioning session will be delayed.

At stage 1806, the method includes receiving positioning measurements associated with the mobile device based at least on the indication that the positioning session will be delayed. The processor 410 and transceiver 415 are means for receiving positioning measurements. In an example, the mobile device may obtain DL PRS measurements from one or more neighboring cells and transmit one or more UL SRS to the neighboring cells. The mobile device may report timing information (e.g., Rx-Tx, RSTD, etc.) and other measurements (AoA, AoD, etc.) to the LMF 120. Neighboring cells may also provide the LMF 120 with positioning measurements associated with the mobile device (e.g., based on the received UL SRS). The LMF 120 may be configured to determine a location of the mobile device based on the techniques provided herein and as known in the art.

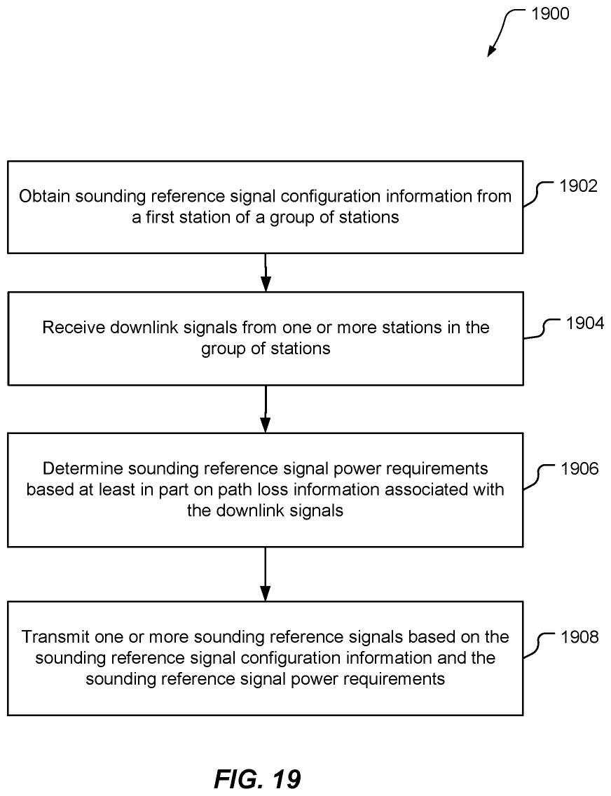

Referring to FIG. 19, with further reference to FIGS. 1-15, a method 1900 for transmitting sounding reference signals based on path loss information associated with a group of stations includes the stages shown. The method 1900 is, however, an example and not limiting. The method 1900 may be altered, e.g., by having stages added, removed, rearranged, combined, performed concurrently, and/or having single stages split into multiple stages.

At stage 1902, the method includes obtaining sounding reference signal configuration information from a first station of a group of stations. A UE 200, including a processor 210 and a transceiver 215, is a means for obtaining SRS configuration information. In an example, the UE 200 may be in a RRC connected mode 902 or the RRC inactive mode 904 and may receive SRS configuration information via RRC signaling such as via a SIB, or other transmissions from a serving cell. In an example, the group of cells may be a RNA 1002 and the SRS configuration information may be included in a RNAU procedure with a serving cell. In an example, the SRS configuration may be received from a network resource, such as the LMF 120, via LPP or other messaging protocols. The SRS configuration information may be a SRS resource, such as the SRS configuration information element 1300.

At stage 1904, the method includes receiving downlink signals from one or more stations in the group of stations. The processor 210 and the transceiver 215 are means for receiving the downlink signals. In an example, the UE 200 may be configured to receive downlink signals such as SSB, TRS, PRS, etc. transmitted by stations in the group of stations. The downlink signals may be utilized as pilot signals in an open loop power control schema and the UE 200 may be configured to perform a channel estimation and determine a path loss based on the received signals. In general, the UE 200 is configured to adjust transmit power based on the path loss because it is assumed that both the forward path (e.g., station to UE) and the reverse path (e.g., UE to station) are correlated.

At stage 1906, the method includes determining sounding reference signal power requirements based at least in part on path loss information associated with the downlink signals. The processor 210 and the transceiver 215 are means for determining the SRS power requirements. The UE 200 may utilize the same SRS configuration for transmitting SRS to each of the stations in the group of stations. In an example, the UE 200 may determine the SRS power requirements based on the path loss of downlink signals transmitted from a current serving cell. In an example, the UE 200 may determine the SRS power requirements based on the path loss of downlink signals transmitted from a new serving cell (e.g., after a handover or reselection procedure). In an example, the UE 200 may determine the SRS power requirements based on the path loss of signals transmitted from a cell which transmitted first during a positioning session. In an example, one specific cell within a RNA may be used to as the positioning SRS path reference. In an option, the UE 200 may determine the path loss associated with downlink signals transmitted from multiple cells and determine the SRS power requirements based on the cell with the lowest path loss.

At stage 1908, the method includes transmitting one or more sounding reference signals based on the sounding reference signal configuration information and the sounding reference signal power requirements. The processor 210 and the transceiver 215 are means for transmitting the one or more sounding reference signals. The UE 200 is configured to determine the uplink power control based on the path loss estimation determined at stage 1906. In an example, the power for the SRS transmission may be based on known techniques, such as described in 3GPP TS 38.213 V17, section 7. The UE 200 may transmit SRS based on an SRS configuration (e.g., SRS-ResourceSet) on an active UL BWP (see, for example, 3GPP TS 38.213 V17, section 7.3.1).

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection. A wireless communication network may not have all communications transmitted wirelessly, but is configured to have at least some communications transmitted wirelessly. Further, the term “wireless communication device,” or similar term, does not require that the functionality of the device is exclusively, or even primarily, for communication, or that communication using the wireless communication device is exclusively, or even primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or ±0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or ±0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

Implementation examples are described in the following numbered clauses:

Clause 1. A method for transmitting sounding reference signals, comprising: obtaining sounding reference signal configuration information from a first station of a group of stations, wherein the sounding reference signal configuration is valid for each station in the group of stations; performing a handover or a cell reselection procedure with a second station, wherein the second station is one of the group of stations; and transmitting one or more sounding reference signals to the second station based on the sounding reference signal configuration information.

Clause 2. The method of clause 1 wherein the group of stations are included in a radio access network notification area.

Clause 3. The method of clause 1 wherein the group of stations are included in a long term evolution radio access network tracking area.

Clause 4. The method of clause 1 wherein the sounding reference signal configuration information is provided via a radio access network notification area update procedure.

Clause 5. The method of clause 1 wherein the second station is configured with a first bandwidth part and the one or more sounding reference signals are transmitted within the first bandwidth part.

Clause 6. The method of clause 1 wherein the sounding reference signal configuration information is included in one or more system information blocks transmitted by the first station.

Clause 7. The method of clause 1 wherein the sounding reference signal configuration information is received by a user equipment in a radio resource control inactive mode.

Clause 8. The method of clause 1 further comprising: receiving one or more downlink reference signals from one or more stations in the group of stations; determining sounding reference signal power requirements based at least in part on path loss information associated with the one or more downlink reference signals; and transmitting the one or more sounding reference signals based at least in part on the sounding reference signal power requirements.

Clause 9. The method of clause 8 wherein the sounding reference signal power requirements are based on one or more downlink reference signals transmitted by the first station.

Clause 10. The method of clause 8 wherein the sounding reference signal power requirements are based on one or more downlink reference signals transmitted by the second station.

Clause 11. The method of clause 8 wherein the one or more downlink reference signals includes a first received downlink reference signal and the sounding reference signal power requirements are based on the first received downlink reference signal.

Clause 12. The method of clause 8 further comprising receiving an indication of a specific cell to be used as a positioning sounding reference signal path reference, wherein the sounding reference signal power requirements are based on the one or more downlink reference signals transmitted by the specific cell.

Clause 13. The method of clause 8 further comprising determining a station associated with a lowest path loss based on the one or more downlink reference signals, wherein the sounding reference signal power requirements are based on one or more downlink reference signals transmitted by the station associated with the lowest path loss.

Clause 14. The method of clause 1 further comprising providing one or more positioning measurements to a network server and receiving a location estimate from the network server based at least in part on the one or more positioning measurements.

Clause 15. A method for transmitting sounding reference signals with a handover or cell reselection procedure, comprising: obtaining a first sounding reference signal configuration from a first station; performing the handover or cell reselection procedure with a second station; requesting a radio access network (RAN) notification area update from the second station; receiving RAN notification area information and a second sounding reference signal configuration from the second station; and transmitting one or more sounding reference signals based on the second sounding reference signal configuration.

Clause 16. The method of clause 15 wherein the first station is configured with a first bandwidth part and the one or more sounding reference signals based on the second sounding reference signal configuration are transmitted within the first bandwidth part.

Clause 17. The method of clause 16 wherein the second station is configured with a second bandwidth part and the one or more sounding reference signals based on the second sounding reference signal configuration are transmitted within the second bandwidth part.

Clause 18. The method of clause 15 wherein the RAN notification area update is included in one or more system information blocks transmitted by the second station.

Clause 19. The method of clause 15 wherein the RAN notification area update is received by a user equipment in a radio resource control inactive mode.

Clause 20. The method of clause 15 further comprising: receiving one or more downlink reference signals from one or more stations identified in the RAN notification area information; determining sounding reference signal power requirements based at least in part on path loss information associated with the one or more downlink reference signals; and transmitting the one or more sounding reference signals based at least in part on the sounding reference signal power requirements.

Clause 21. The method of clause 20 wherein the sounding reference signal power requirements are based on one or more downlink reference signals transmitted by the first station.

Clause 22. The method of clause 20 wherein the sounding reference signal power requirements are based on one or more downlink reference signals transmitted by the second station.

Clause 23. The method of clause 20 wherein the one or more downlink reference signals includes a first received downlink reference signal and the sounding reference signal power requirements are based on the first received downlink reference signal.

Clause 24. The method of clause 20 further comprising receiving, in the RAN notification area information, an indication of a specific cell to be used as a positioning sounding reference signal path reference, wherein the sounding reference signal power requirements are based on the one or more downlink reference signals transmitted by the specific cell.

Clause 25. The method of clause 20 further comprising determining a station associated with a lowest path loss based on the one or more downlink reference signals, wherein the sounding reference signal power requirements are based on one or more downlink reference signals transmitted by the station associated with the lowest path loss.

Clause 26. The method of clause 20 further comprising providing one or more positioning measurements to a network server and receiving a location estimate from the network server based at least in part on the one or more positioning measurements.

27. A method for delaying a positioning session based on a handover or cell reselection procedure, comprising: requesting positioning information associated with a mobile device; receiving an indication that the positioning session will be delayed based on a time required to complete the handover or cell reselection procedure; and receiving positioning measurements associated with the mobile device based at least in part on the indication that the positioning session will be delayed.

Clause 28. The method of clause 27 wherein the indication that the positioning session will be delayed is received from a mobility management function.

Clause 29. The method of clause 27 wherein the indication that the positioning session will be delayed is based on historical handover or cell reselection procedures times associated with a first station and a second station.

30. An apparatus, comprising: at least one memory; at least one transceiver; at least one processor communicatively coupled to the at least one memory and the at least one transceiver, and configured to: obtain sounding reference signal configuration information from a first station of a group of stations, wherein the sounding reference signal configuration is valid for each station in the group of stations; perform a handover or a cell reselection procedure with a second station, wherein the second station is one of the group of stations; and transmit one or more sounding reference signals to the second station based on the sounding reference signal configuration information.

Clause 31. The apparatus of clause 30 wherein the group of stations are included in a radio access network notification area.

Clause 32. The apparatus of clause 30 wherein the group of stations are included in a long term evolution radio access network tracking area.

Clause 33. The apparatus of clause 30 wherein the at least one processor is further configured to receive a radio access network notification area update, and the sounding reference signal configuration information is provided via the radio access network notification area update.

Clause 34. The apparatus of clause 30 wherein the second station is configured with a first bandwidth part and the one or more sounding reference signals are transmitted within the first bandwidth part.

Clause 35. The apparatus of clause 30 wherein the at least one processor is further configured to receive one or more system information blocks transmitted by the first station, and the sounding reference signal configuration information is included in the one or more system information blocks transmitted by the first station.

Clause 36. The apparatus of clause 30 wherein the at least one processor is further configured to receive the sounding reference signal configuration information while in a radio resource control inactive mode.

Clause 37. The apparatus of clause 30 wherein the at least one processor is further configured to: receive one or more downlink reference signals from one or more stations in the group of stations; determine sounding reference signal power requirements based at least in part on path loss information associated with the one or more downlink reference signals; and transmit the one or more sounding reference signals based at least in part on the sounding reference signal power requirements.

Clause 38. The apparatus of clause 37 wherein the sounding reference signal power requirements are based on one or more downlink reference signals transmitted by the first station.

Clause 39. The apparatus of clause 37 wherein the sounding reference signal power requirements are based on one or more downlink reference signals transmitted by the second station.

Clause 40. The apparatus of clause 37 wherein the one or more downlink reference signals includes a first received downlink reference signal and the sounding reference signal power requirements are based on the first received downlink reference signal.

Clause 41. The apparatus of clause 37 wherein the at least one processor is further configured to receive an indication of a specific cell to be used as a positioning sounding reference signal path reference, wherein the sounding reference signal power requirements are based on the one or more downlink reference signals transmitted by the specific cell.

Clause 42. The apparatus of clause 37 wherein the at least one processor is further configured to determine a station associated with a lowest path loss based on the one or more downlink reference signals, wherein the sounding reference signal power requirements are based on one or more downlink reference signals transmitted by the station associated with the lowest path loss.

Clause 43. The apparatus of clause 30 wherein the at least one processor is further configured to provide one or more positioning measurements to a network server and receive a location estimate from the network server based at least in part on the one or more positioning measurements.

Clause 44. An apparatus, comprising: at least one memory; at least one transceiver; at least one processor communicatively coupled to the at least one memory and the at least one transceiver, and configured to: obtain a first sounding reference signal configuration from a first station; perform a handover or cell reselection procedure with a second station; request a radio access network (RAN) notification area update from the second station; receive RAN notification area information and a second sounding reference signal configuration from the second station; and transmit one or more sounding reference signals based on the second sounding reference signal configuration.

Clause 45. The apparatus of clause 44 wherein the first station is configured with a first bandwidth part and the at least one processor is further configured to transmit the one or more sounding reference signals based on the second sounding reference signal configuration within the first bandwidth part.

Clause 46. The apparatus of clause 45 wherein the second station is configured with a second bandwidth part and the at least one processor is further configured to transmit the one or more sounding reference signals based on the second sounding reference signal configuration within the second bandwidth part.

Clause 47. The apparatus of clause 44 wherein the RAN notification area update is included in one or more system information blocks transmitted by the second station.

Clause 48. The apparatus of clause 44 wherein the at least one processor is further configured to receive the RAN notification area information while in a radio resource control inactive mode.

Clause 49. The apparatus of clause 44 wherein the at least one processor is further configured to: receive one or more downlink reference signals from one or more stations identified in the RAN notification area information; determine sounding reference signal power requirements based at least in part on path loss information associated with the one or more downlink reference signals; and transmit the one or more sounding reference signals based at least in part on the sounding reference signal power requirements.

Clause 50. The apparatus of clause 49 wherein the sounding reference signal power requirements are based on one or more downlink reference signals transmitted by the first station.

Clause 51. The apparatus of clause 49 wherein the sounding reference signal power requirements are based on one or more downlink reference signals transmitted by the second station.

Clause 52. The apparatus of clause 49 wherein the one or more downlink reference signals includes a first received downlink reference signal and the sounding reference signal power requirements are based on the first received downlink reference signal.

Clause 53. The apparatus of clause 49 wherein the at least one processor is further configured to receive, in the RAN notification area information, an indication of a specific cell to be used as a positioning sounding reference signal path reference, wherein the sounding reference signal power requirements are based on the one or more downlink reference signals transmitted by the specific cell.

Clause 54. The apparatus of clause 49 wherein the at least one processor is further configured to determine a station associated with a lowest path loss based on the one or more downlink reference signals, wherein the sounding reference signal power requirements are based on one or more downlink reference signals transmitted by the station associated with the lowest path loss.

Clause 55. The apparatus of clause 49 wherein the at least one processor is further configured to provide one or more positioning measurements to a network server and receiving a location estimate from the network server based at least in part on the one or more positioning measurements.

Clause 56. An apparatus, comprising: at least one memory; at least one transceiver; at least one processor communicatively coupled to the at least one memory and the at least one transceiver, and configured to: request positioning information associated with a mobile device; receive an indication that a positioning session will be delayed based on a time required to complete a handover or cell reselection procedure; and receive positioning measurements associated with the mobile device based at least in part on the indication that the positioning session will be delayed.

Clause 57. The apparatus of clause 56 wherein the indication that the positioning session will be delayed is received from a mobility management function.

Clause 58. The apparatus of clause 56 wherein the indication that the positioning session will be delayed is based on historical handover or cell reselection procedures times associated with a first station and a second station.

Clause 59. An apparatus for transmitting sounding reference signals, comprising: means for obtaining sounding reference signal configuration information from a first station of a group of stations, wherein the sounding reference signal configuration is valid for each station in the group of stations; means for performing a handover or a cell reselection procedure with a second station, wherein the second station is one of the group of stations; and means for transmitting one or more sounding reference signals to the second station based on the sounding reference signal configuration information.

Clause 60. An apparatus for transmitting sounding reference signals with a handover or cell reselection procedure, comprising: means for obtaining a first sounding reference signal configuration from a first station; means for performing the handover or cell reselection procedure with a second station; means for requesting a radio access network (RAN) notification area update from the second station; means for receiving RAN notification area information and a second sounding reference signal configuration from the second station; and means for transmitting one or more sounding reference signals based on the second sounding reference signal configuration.

Clause 61. An apparatus for delaying a positioning session based on a handover or cell reselection procedure, comprising: means for requesting positioning information associated with a mobile device; means for receiving an indication that the positioning session will be delayed based on a time required to complete the handover or cell reselection procedure; and means for receiving positioning measurements associated with the mobile device based at least in part on the indication that the positioning session will be delayed.

Clause 62. A non-transitory processor-readable storage medium comprising processor-readable instructions configured to cause one or more processors to transmit sounding reference signals, comprising code for: obtaining sounding reference signal configuration information from a first station of a group of stations, wherein the sounding reference signal configuration is valid for each station in the group of stations; performing a handover or a cell reselection procedure with a second station, wherein the second station is one of the group of stations; and transmitting one or more sounding reference signals to the second station based on the sounding reference signal configuration information.

Clause 63. A non-transitory processor-readable storage medium comprising processor-readable instructions configured to cause one or more processors to transmit sounding reference signals with a handover or cell reselection procedure, comprising code for: obtaining a first sounding reference signal configuration from a first station; performing the handover or cell reselection procedure with a second station; requesting a radio access network (RAN) notification area update from the second station; receiving RAN notification area information and a second sounding reference signal configuration from the second station; and transmitting one or more sounding reference signals based on the second sounding reference signal configuration.

Clause 64. A non-transitory processor-readable storage medium comprising processor-readable instructions configured to cause one or more processors to delay a positioning session based on a handover or cell reselection procedure, comprising code for: requesting positioning information associated with a mobile device; receiving an indication that the positioning session will be delayed based on a time required to complete the handover or cell reselection procedure; and receiving positioning measurements associated with the mobile device based at least in part on the indication that the positioning session will be delayed.

1. A method for transmitting sounding reference signals, comprising:
obtaining sounding reference signal configuration information from a first station of a group of stations, wherein the sounding reference signal configuration information is valid for each station in the group of stations;
performing a handover or a cell reselection procedure with a second station, wherein the second station is one of the group of stations; and
transmitting one or more sounding reference signals to the second station based on the sounding reference signal configuration information.

2. The method of claim 1 wherein the group of stations are included in a radio access network notification area.

3. The method of claim 1 wherein the group of stations are included in a long term evolution radio access network tracking area.

4. The method of claim 1 wherein the sounding reference signal configuration information is provided via a radio access network notification area update procedure.

5. The method of claim 1 wherein the second station is configured with a first bandwidth part and the one or more sounding reference signals are transmitted within the first bandwidth part.

6. The method of claim 1 wherein the sounding reference signal configuration information is included in one or more system information blocks transmitted by the first station.

7. The method of claim 1 wherein the sounding reference signal configuration information is received by a user equipment in a radio resource control inactive mode.

8. The method of claim 1 further comprising:
receiving one or more downlink reference signals from one or more stations in the group of stations;
determining sounding reference signal power requirements based at least in part on path loss information associated with the one or more downlink reference signals; and
transmitting the one or more sounding reference signals based at least in part on the sounding reference signal power requirements.

9. The method of claim 8 wherein the sounding reference signal power requirements are based on one or more downlink reference signals transmitted by the first station.

10. The method of claim 8 wherein the sounding reference signal power requirements are based on one or more downlink reference signals transmitted by the second station.

11. The method of claim 8 wherein the one or more downlink reference signals includes a first received downlink reference signal and the sounding reference signal power requirements are based on the first received downlink reference signal.

12. The method of claim 8 further comprising receiving an indication of a specific cell to be used as a positioning sounding reference signal path reference, wherein the sounding reference signal power requirements are based on the one or more downlink reference signals transmitted by the specific cell.

13. The method of claim 8 further comprising determining a station associated with a lowest path loss based on the one or more downlink reference signals, wherein the sounding reference signal power requirements are based on one or more downlink reference signals transmitted by the station associated with the lowest path loss.

14. The method of claim 1 further comprising providing one or more positioning measurements to a network server and receiving a location estimate from the network server based at least in part on the one or more positioning measurements.

15. A method for transmitting sounding reference signals with a handover or a cell reselection procedure, comprising:
obtaining a first sounding reference signal configuration from a first station;
performing the handover or the cell reselection procedure with a second station;
requesting a radio access network (RAN) notification area update from the second station;
receiving RAN notification area information and a second sounding reference signal configuration from the second station; and
transmitting one or more sounding reference signals based on the second sounding reference signal configuration.

16. The method of claim 15 wherein the first station is configured with a first bandwidth part and the one or more sounding reference signals based on the second sounding reference signal configuration are transmitted within the first bandwidth part.

17. The method of claim 16 wherein the second station is configured with a second bandwidth part and the one or more sounding reference signals based on the second sounding reference signal configuration are transmitted within the second bandwidth part.

18. The method of claim 15 wherein the RAN notification area update is included in one or more system information blocks transmitted by the second station.

19. The method of claim 15 wherein the RAN notification area update is received by a user equipment in a radio resource control inactive mode.

20. The method of claim 15 further comprising:
receiving one or more downlink reference signals from one or more stations identified in the RAN notification area information;
determining sounding reference signal power requirements based at least in part on path loss information associated with the one or more downlink reference signals; and
transmitting the one or more sounding reference signals based at least in part on the sounding reference signal power requirements.

21. The method of claim 20 wherein the sounding reference signal power requirements are based on one or more downlink reference signals transmitted by the first station.

22. The method of claim 20 wherein the sounding reference signal power requirements are based on one or more downlink reference signals transmitted by the second station.

23. The method of claim 20 wherein the one or more downlink reference signals includes a first received downlink reference signal and the sounding reference signal power requirements are based on the first received downlink reference signal.

24. The method of claim 20 further comprising receiving, in the RAN notification area information, an indication of a specific cell to be used as a positioning sounding reference signal path reference, wherein the sounding reference signal power requirements are based on the one or more downlink reference signals transmitted by the specific cell.

25. The method of claim 20 further comprising determining a station associated with a lowest path loss based on the one or more downlink reference signals, wherein the sounding reference signal power requirements are based on one or more downlink reference signals transmitted by the station associated with the lowest path loss.

26. The method of claim 20 further comprising providing one or more positioning measurements to a network server and receiving a location estimate from the network server based at least in part on the one or more positioning measurements.

27. An apparatus, comprising:
at least one memory;
at least one transceiver;
at least one processor communicatively coupled to the at least one memory and the at least one transceiver, and configured to:
obtain sounding reference signal configuration information from a first station of a group of stations, wherein the sounding reference signal configuration information is valid for each station in the group of stations;
perform a handover or a cell reselection procedure with a second station, wherein the second station is one of the group of stations; and
transmit one or more sounding reference signals to the second station based on the sounding reference signal configuration information.

28. The apparatus of claim 27 wherein the at least one processor is further configured to:
receive one or more downlink reference signals from one or more stations in the group of stations;
determine sounding reference signal power requirements based at least in part on path loss information associated with the one or more downlink reference signals; and
transmit the one or more sounding reference signals based at least in part on the sounding reference signal power requirements.

29. An apparatus, comprising:
at least one memory;
at least one transceiver;
at least one processor communicatively coupled to the at least one memory and the at least one transceiver, and configured to:
obtain a first sounding reference signal configuration from a first station;
perform a handover or cell reselection procedure with a second station;
request a radio access network (RAN) notification area update from the second station;
receive RAN notification area information and a second sounding reference signal configuration from the second station; and
transmit one or more sounding reference signals based on the second sounding reference signal configuration.

30. The apparatus of claim 29 wherein the at least one processor is further configured to:
receive one or more downlink reference signals from one or more stations identified in the RAN notification area information;
determine sounding reference signal power requirements based at least in part on path loss information associated with the one or more downlink reference signals; and
transmit the one or more sounding reference signals based at least in part on the sounding reference signal power requirements.
